(19) United States
(12) Patent Application Publication
(10) Pub. No.: US 2024/0249628 A1
(43) Pub. Date: Jul. 25, 2024

(54) AIML SMART VERTIPORT IN A BOX AUTONOMOUS MULTIMODAL PHYSICAL AND DIGITAL INFRASTRUCTURE

(71) Applicant: Michele DiCosola, Bloomingdale, IL (US)

(72) Inventor: Michele DiCosola, Bloomingdale, IL (US)

(73) Assignee: Michele DiCosola, Bloomingdale, IL (US)

(21) Appl. No.: 18/461,843

(22) Filed: Sep. 6, 2023

Related U.S. Application Data
(63) Continuation-in-part of application No. 18/451,476, filed on Aug. 17, 2023, now abandoned.
Application No. 18/451,476 is a continuation of application No. 16/866,484, filed on May 4, 2020.
Application No. 18/451,476 is a continuation of application No. 17/951,091, filed on Sep. 22, 2022.
(60) Provisional application No. 62/842,757, filed on May 3, 2019.

(30) Foreign Application Priority Data
Feb. 28, 2021 (CA) CA3177091A

(51) Int. Cl. G08G 5/00; B64C 39/02; B64U 101/60; G06Q 10/0832; G06Q 20/20

(52) U.S. Cl. CPC G08G 5/0013; B64C 39/024; G06Q 10/0832; G06Q 20/20; G08G 5/0043; G08G 5/0069; B64U 2101/60; B64U 2201/104

(57) ABSTRACT

The present invention provides a vertiport system for managing unmanned vehicles in delivering goods or passengers from a source location to a destination location. The user using the computing device access a delivery system in order to get a good delivered to user location. Once the user places an order for delivery and the Vertiport system assigns an unmanned vehicle and an unmanned flight planner determines a route considering various factors like distance, weather conditions etc. and shares the same with the unmanned vehicle.

### CROSS-REFERENCE TO RELATED APPLICATION

This application is a continuation-in-part of U.S. patent application Ser. No. 18/451,476, filed on Aug. 17, 2023, titled “SMART DELIVERY DOORBELL AND CHIME DATA BLOCKCHAIN MINER WITH CRYPTO AND TOKEN INTEGRATION AND SMART UAV LANDING PAD DATA MINER” which claims benefit of U.S. patent application Ser. No. 16/866,484, filed May 4, 2020, titled “SMART DRONE ROOFTOP AND GROUND AIRPORT SYSTEM” which further claims benefit of U.S. Provisional Patent Application Ser. No. 62/842,757 filed May 2, 2019, titled “UNIVERSAL AUTOMATED ARTIFICIAL INTELLIGENT ROOFTOP UAS/UAV DRONE PORT/AIRPORT STATION FOR GENERAL PURPOSE SERVICES OF ROBOTIC UAS/UAVS, AND ITS SUPPORTING HARDWARE & EQUIPMENT RELATED TO; LOADING/UNLOADING, DELIVERIES, DEPLOYMENT/ARRIVAL, DISPATCHING, AIR TRAFFIC CONTROL, CHARGING, STORING/GARAGING, DE-ICING/ANTI-ICING, METEOROLOGICAL & DATA DISSEMINATION/RETRIEVAL, BIG DATA MINING, AND MIMO NETWORK SERVICES” the entire disclosure of which is incorporated by reference herein.

This application is also claims priority to related, commonly owned, and pending U.S. patent application Ser. No. 17/951,091 filed on Sep. 22, 2022, titled “CUSTOM ADVERTISING AND BRAND WRAPS FOR SMART DRONES” the entire disclosure of which is incorporated by reference herein.

This application is also claims priority to related, commonly owned, and pending Canada patent application Serial No. CA3177091A filed on Feb. 28, 2021, titled “SMART CITY SMART DRONE UASS/UAV/VTOL SMART MAILBOX LANDING PAD” which further claims benefit of U.S. patent application Ser. No. 16/866,484, filed May 4, 2020, titled “SMART DRONE ROOFTOP AND GROUND AIRPORT SYSTEM” which further claims benefit of U.S. Provisional Patent Application Ser. No. 62/983,486 filed Feb. 28, 2020 the entire disclosure of which is incorporated by reference herein.

### FIELD OF THE INVENTION

The present invention generally relates to management of unmanned vehicles by vertiport management system.

### BACKGROUND OF THE INVENTION

Small, personal, automated aircraft can provide efficient transportation, as they can travel direct routes. They may be especially efficient in areas of dense population with heavy road traffic. However, dense traffic areas such as cities typically have limited and expensive real estate, and there typically are not large areas of available land that would be suitable for an airport within cities.

There is generally a wide variety of modes of transport available within cities. People may walk, ride a bike, drive a car, take public transit, use a ride sharing service, and the like. However, as population densities and demand for land increase, many cities are increasingly experiencing problems with traffic congestion and the associated pollution. Consequently, there is a need to expand the available modes of transport in ways that may reduce the amount of traffic without requiring the use of large amounts of land.

Air travel within cities has been limited compared to ground travel. Air travel can have a number of requirements making intra-city air travel difficult. For instance, aircraft can require significant resources such as fuel and infrastructure (e.g., runways), produce significant noise, and require significant time for boarding and alighting, each presenting technical challenges for achieving larger volume of air travel within cities or between neighboring cities. However, providing such air travel may reduce travel time over purely ground-based approaches as well as alleviate problems associated with traffic congestion.

Therefor there is a need for vertiport system for managing unmanned vehicles for the purpose of delivery of goods or transporting of passengers from one location to the other location.

### SUMMARY OF THE INVENTION

The present invention is related to vertiport system for managing unmanned vehicles. The system provides an Autonomous Artificial Intelligent/machine Learning based Unmanned Vehicle Vertiport station, the station being for general purpose services of robotic Unmanned Vehicles, and its supporting hardware & equipment related to loading and unloading, deliveries, deployment and arrival, dispatching, air traffic control, charging, storing and garaging, meteorological & data dissemination and retrieval. The Vertiport system includes unmanned vehicles, unmanned aerial vehicles, Drones and is supported by a Unmanned Vehicle Operating System (UVOS) Drone Operating System (DOS) and provides the following capabilities: 1) unmanned vehicle on demand delivery services; 2) unmanned vehicles are parked, stored, and/or charged in the garage and/or on a landing pad, smart mailbox landing pad and/or on a portable landing pad; 3) Orders are made via mobile, land, and TV applications using wired and/or wireless connections; 4) unmanned vehicle or Drone AI Cloud (Artificial Intelligence Cloud) figures out if the weather permits deliver to and from the location requested at the time requested; 5) unmanned vehicle or Drone AI Cloud will figure out which unmanned vehicle or drone is available, using the fastest, most convenient, safest and properly equipped vehicle for the weather conditions, payload requirements, and any other specific demand option(s); 6) the app then confirms the customer has elected that option, then proceeds to the customer order specifications, then proceeds to pre-paid through the mobile, land, or TV app, where they will receive an automatic text, push notification, and or email, of their receipt and purchase; 7) The vendor is automatically informed on their POS system and in their department of interest (shipping, kitchen, lab or pharmacy dispensary, etc.) in the location, that the order has been placed, the customer has paid in full and has elected to use the unmanned vehicle Delivery Hailing Option 8) The UTM deploys the unmanned vehicle to the landing pad for loading/unloading, drop off and pickup; 9) The unmanned vehicle is loaded and departs to its destination; 10) The drone delivers arrives at its destination, rings the smart doorbell (if available) and sends a text message and or push notification of its arrival, confirms the receiver of the package, releases the product to the consumer and informs the POS that the order has been delivered.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

The novel features of the disclosure are set forth here. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a smart AI/ML Autonomous Vertiport System for Unmanned Vehicle Management according to the present invention.

FIG. 2 illustrates notifying system between an unmanned vehicle and various customer devices regarding a package delivery according to the present invention.

FIG. 3 illustrates an unmanned vehicle carrying a delivery good.

FIG. 4 illustrates a good delivery system through a drone or unmanned vehicle, in accordance with an embodiment of the present invention.

FIG. 5 illustrates a smart mailbox landing pad for pickup/delivery of a good.

FIG. 6 illustrates a smart rooftop landing pad at a house.

FIG. 7 illustrates various smart drone landing pads used by unmanned vehicle during landing/take-off procedures according to the present invention.

FIG. 8 illustrates a Vertiport-in-a-Box attached to a house.

FIG. 9 illustrates a Droneport/Vertiport based good delivery system according to the present invention.

### DETAILED DESCRIPTION OF THE INVENTION

In the following description, numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

In The foregoing and other aspects of the present disclosure are described in further detail in the sections that follow. It should be noted that the term “blockchain” is often used interchangeably with the term “distributed ledger”; accordingly, the term “distributed ledger” as used herein should be broadly interpreted as including both blockchains and other types of distributed ledgers that do not employ this particular data structure/format.

The term “cryptocurrency” may mean a digital currency in which encryption techniques are used to regulate the generation of units of currency and verify the transfer of funds. Many cryptocurrencies include the use of a blockchain to provide rewards, governance, data validation, mining, ledgering, security and prevent fraud as double spending. Some embodiments of the present disclosure may be used in alternate cryptocurrency mechanisms other than a blockchain. The system, method, and computer program products described herein may be applied to both centralized and decentralized cryptocurrency networks and databases.

In one embodiment, the invention is related to SMART AI/ML AUTONOMOUS VERTIPORT SYSTEM FOR UNMANNED VEHICLE MANAGEMENT in Physical and Autonomous Shipping and Delivery of Cargo and People using unmanned vehicles, drones, eVTOLs, VTOLs, UGVs, UMVs, robots or vehicles. The system can be utilized for home and commercial delivery operations and also, in all public and private sectors.

In one embodiment, the system includes but not limited to smart charging or landing pad, unmanned vehicle drive through window, unmanned vehicle sliding shelf, quick change unmanned vehicle battery station, anti-unmanned vehicle detector, unmanned vehicle elevator, hatch manual or automatic door entry/exit, ATC base station, UTM base station, unmanned vehicle repair station, unmanned vehicle charging station, smart mailbox landing pad, weather station, smart glasses, smart controllers and Smart Delivery Doorbell.

In one embodiment, the smart delivery doorbell can be but not limited to Smart Doorbell, Delivery Doorbell, Doorbell, Intelligent Doorbell, Smart doorbell to lock/unlock door, etc.

In one embodiment, the unmanned vehicle can be but not limited to a drone, an unmanned aerial vehicle (UAV), an unmanned ground vehicle (UGV), a water vehicle or an unmanned marine vehicle (UMV).

In one embodiment, the smart drone landing pad further connects to a remote smart doorbell, and a wireless smart watch. The remote smart doorbell and the wireless smart watch receive package delivery notification from the processing node within the smart drone landing pad upon receipt of a package.

In another embodiment, the Smart Delivery Doorbell will be used for notifying the user the delivery of goods. The delivery of cargo is done using unmanned vehicles. The hardware will be able to have scalable, interoperable, and modular sensors, data agnostic, and services that can range based on need.

In some embodiments, the unmanned vehicles can be equipped but not limited to camera sensors, light sensors, solar panels for charging, wireless networking sensors, collision avoidance detection sensors or temperature sensors etc.

In some embodiments, the system makes all the equipment including unmanned vehicle, smart landing pad, smart doorbell, charging station, container, weather tower or smart glasses etc. act as data miners and provide data miner blockchain node solutions on a node centric HGTP Layer 0/Layer 1 data network using smart contracts, state channels, NFTs, NFRs, AIML or OpenAI (ChatGTP).

In one embodiment, the system further includes a CRM and Multilevel marketing, sales and services entities connected to the system.

In one embodiment, the unmanned vehicle can be but not limited to autonomous, semi-autonomous and or remotely and manually operated.

In one embodiment, the system is connected to a metaverse solution where a user can interact with all the physical nodes through virtual world.

In one embodiment, the system includes Pilots who wear the Smart glasses with VR AR XR HR and can be used for controlling the unmanned vehicle or interact the physical world virtually through connecting to metaverse. They can also connect the smart glasses to the weather sensor to see real world weather. The Smart Glasses will have optical lenses that will automatically adjust to the eyes of the user/pilot and the frames of the smart glasses can be interchangeable as per the user/pilot requirements and will be equipped with OpenAI and ChartGPT.

In one embodiment, the system is an AI/ML Multimodal Automation Infrastructure Transportation app for the delivery of people and cargo. The system acts as a Vertiport in a Box and Drone in a Box system and provides auxiliary solutions. The system includes validated trusted data that is discoverable and has a DDBOR with Smart Contract NRF rights and loyal, social and carbon credit, ESG rewards.

In one embodiment, the unmanned vehicle of the system includes hybrid multimodal fuel tank i.e. it can run on hydrogen or electric charge.

In one embodiment, the components/auxiliaries of the system further includes but not limited to: Router Pulling, Sharing, Rent data connection to other people based on data used, Zero Point Field Energy (anything requiring energy), Ion Propulsion (anything that moves), Induction battery charging and AI Smart Drone Delivery Container is equipped with HVAC system and auto battery system.

In one embodiment, The system while in process of transporting goods, selects either the unmanned vehicle's next destination for charging, based upon its remaining battery use and the vacancy availability of the next landing pad to frog leap to if needed and or the nearest vacant charging station/hanger, then sends it to its next order, or parks it at a nearest Smart Rooftop AirPort Parking Station, where it can recharge and wait for further instructions.

In some embodiments, the system provides a power supply device for charging and fuelling the unmanned vehicle, an inspection device for inspecting the unmanned vehicle, and a maintenance device for repair or maintenance of the unmanned vehicle may be provided.

In one embodiment, system can be used for surveillance and can deploy a security drone for monitoring and tracking of the target/suspect. The system connects to all cooperating law enforcement entities and other cooperating commands centres where they can see in real time the situational awareness of the crime while recording for memorialization the video and audio.

In one embodiment, the system further includes an AI/ML Smart Cloud Router which will be able to mine and validate data inside a home or business location while connected to smart exterior devices which can also mine and validate data.

In some embodiments, the system is equipped with solar panels and/or wind turbines for roof and ground stations for generating electricity which is further used within the system by various components.

In one embodiment, unmanned vehicles can be equipped with non-lethal deterrents, restraints, tracking devices nets, tasers, tire puncturing solutions, emp's to stop vehicles etc. that can be deployed on the target. The unmanned vehicles can autonomously provide services to commission additional unmanned vehicles for swarm surveillance and ISR solutions. Facial, voice, body, object, vehicle recognition.

In some embodiments, an unmanned vehicle flies the next of what may be multiple legs, waypoints, stations and or vectors, of the mission. A) it consults its itinerary and the real time and or near real time data between decentralized nodes, to see which node is next; B) it communicates in an authenticated way to ensure that the next node is ready for its arrival; C) as it arrives at another node, it updates its schedule of commitments and activity logs which synchronizes throughout all participating parties and nodes within the network; D) if along the way, the drone finds that it must update its itinerary because a node that had been included is no longer available or is reporting to have weather that is not adequate for flight and or ground delivery, it will ask the Drone Flight Planner (DFP) to update the itinerary and the changes will be pushed to the affected downstream nodes; and E) when the drone arrives at the destination node, the delivery will be made, a notification to the smart doorbell will be wirelessly rang with or without the smart doorbell chime, with a text, messenger, video, and or push notification on a smart watch, smart phone, smart tv, and or online will be given to the end user will authenticate the receipt of the delivery via mobile app, mobile phone, biometric identification, wand, and or any other authentication means, the drone will open the smart container, smart landing pad, smart mailbox landing pad, or smart parcel drone landing pad, the receiving party, smart container, smart landing pad, smart mailbox landing pad, or smart parcel drone landing pad will close the container or the receiving party will accept the disposable container, the drone missions database (DMDB) will be updated to record the finished mission on the participating blockchain, HGTP, metagraph, node centric mesh layer 0 and layer 1 network(s), state channel(s), smart contract, NFTs, autonomous mobility data exchange, as trusted validated data that is discoverable with rights attached, and the drone will either charge there or move on to a recharge station if the destination is not capable of recharging the node, head back to home base such as the smart rooftop and ground droneport/vertiport/airport and or head to the next mission if capable.

In some embodiments, the system includes using an existing semiconductor, with a single crystalline diamond (scd) in the dnv unit with the option to stack the dnv's (other misc materials are ceramic and metal among other materials to form a dnv/tritium battery, this allows for quickly turning contained radiation into electricity that has the potential to last equal to and or longer than the hardware life use.

In some embodiments, the dnv/tritium battery(ies) will be able to be integrated with any blockchain, blockchain utility token, ai/ml, iot, edge computing, cloud network system(s) with a node or node(s) (machine(s)) such as with our smart delivery drone on the smart drone rooftop and ground droneport/vertiport/airport utility infrastructure system, smart vertiport in a box system, smart droneport in a box system, smart drone in a box system, smart mailbox landing pad, smart landing pad, smart drone garage/hanger/charging station, smart drone doorbell smart sensors, smart meteorology equipment and or anything else that can be introduced into the system as a node.

In some embodiments, every node introduced into the smart rooftop and ground droneport/vertiport/airport is a machine, every machine will have the option to integrate with and or replace existing batteries using a dnv/tritium battery for an energy resource.

In some embodiments, node internet of things (iot) edge computing with cloud integration, ai, ml, and blockchain will be able to allow long term life use of the machine hardware when combined with the dnv/tritium battery.

In some embodiments, the system with nodes (machines) integrating dnv/tritium batteries, can be open platform and can be agnostic, holistic, interoperable, modular and scaleable.

In some embodiments, our smart drone rooftop and ground droneport/airport system is designed throughout with blockchain and low-latency blockchain consensus block chain capabilities for any and or all data that will be going through the system via nodes.

In some embodiments, data can consist of any type and or size of data from any type of node collecting it, such as: static and or dynamic video, audio, sensor data, from both internal and or external information that are nano, macro, meso and or micro. This data information is integrated with cloud, iot, sensors (nodes), ai/ml and blockchain, that are collecting and recording data in real time at the node location for low latency, performance, telemetry, iot, and dissemination of data to other devices (nodes) that are part of the network (smart phones, laptops, smart tvs, ipads, etc).

In some embodiments, the system includes smart edge computing servers that process the data from the node and distribute it to cloud which then sends it to all participating devices (nodes)

In some embodiments, encryption on data will be verified prior to distribution

In some embodiments, blockchain will ledger, harvest, record all the data information at all stages from nodes in the network for current or future use from any node that is part of the network. This data can be used as a node blockchain utility token because the data is a blockchain based asset that can be purchased, licensed and or leased, with the intent to use and or sell later.

In some embodiments, any machine (node) on the internal network and or connected to another external machine, network and or system, can be integrated as a node which will collect data to be processed and monetized for present or future use as a node blockchain based asset using either system utility token and or a third part utility token to transact business from the data use and or distribution thereof.

In some embodiments, the system collected data can be integrated with other network systems, data and or machines who have its own data from its own nodes we have identified and authorized by use of its apis, sdks, and or any other software, firmware, saas, paas, daas, iasss, that can be available for integration.

In some embodiments, nodes will be able to communicate data and process through ai/ml (artificial intelligence/machine learning) and will be able to make real time decisions or plan to use that data in the near and or distant future.

In some embodiments, an example would be a drone (node) that was preparing for a: pre-flight system check, flight planning, prefight authorization, weather forecast between waypoints, and availability of the drone landing pad and or drone charging stations before final destination, in addition to emergency flight changes and landing locations using a droneport/vertiport/airport/landing pad. This drone (node) may need to communicate with the landing pad (node) destination and or waypoint, the en-route drones (drones0 that are using a similar virtual route/waypoint and are currently in flight. While in flight, these en-route drones will have sensors (nodes) that will be able to collect real time data that will be able to be used by the pre-flight drone through ai/ml. The pre-flight drone may calculate the weather probability and requirements of the payload delivery and determine that the best, least expensive, highest probability of success and or safest route of flight is a different waypoint to avoid weather. While at the same time, taking in node data from another system that is reporting a plane (non-cooperating (not in the system network as an internal node) will be flying in the area over the next 5 minutes that will need to be avoided. This may delay the take-off of the drone in pre-flight. The pre-flight drone has now been able to take all the real time data from each resource and figure out the path of least resistance and success.

In one embodiment, nodes (machines) will play a very important role in the collection, preservation and recordation of data. This data can be authenticated, encrypted, validated, collected, shared, sorted, and filed backed up and saved in libraries for real time and or future use. Using blockchain to track every single action and transaction from start to finish.

In some embodiments, edge computing for iot connected to a cloud network will allow for very low latency processing at the node location.

In some embodiments, data can then be monetized as a blockchain asset and utility token.

In some embodiments, some examples of monetized data would be: weather data, safety management system data reports, safety risk management data reports, mission data reports, mapping data reports, video, audio, dynamic and static.

In some embodiments, blockchain and blink chain/low-latency blockchain consensus algorithm, are integrated with byzantine, rings, shards, nodes, validators, among other programing techniques that will decrease consensus latency, while maintaining security in a byzantine fault tolerant scenario know as blink chain, a latency-aware blockchain that provides bounds on consensus latency. It selects validators for the blockchain in each shard to achieve low-latency consensus among validators from the crux which enhances scalable distributed protocols with low latency while maintaining the security guarantee that an adversary cannot take over a particular shard by focusing its efforts within the vicinity of the shard.

In some embodiments, examples of machine nodes for air, ground and water that can provide data includes but not limited to smart drone (EV, EVTOL, VTOL, UAV, UAS, UMV, USV, AMV), smart drone landing pad, smart drone charging station, smart droneport, smart droneport and charging station, smart drone garage/hanger, smart drone doorbell, smart drone sensors, smart drone mailbox landing pad, smart drone landing pad, meteorological equipment, weather sensors, camera, de-icer, anti-icer, light fixtures and systems, drone shoots, drone elevators, drone shafts, mobile devices or network hardware.

In some embodiments, examples of node cross communications using data with ai/ml for real time or near real time decision making includes but not limited to drone to drone and or drone to drones that are en-route, departure drone to en-route drones to arrival drones (or a combination thereof), smart drone landing pad to drone pre-flight, departure, en-route and or arrival (or a combination thereof), smart droneport to droneport, smart drone garage/hanger to smart drone garage/hanger, waypoint weather stations to waypoint weather station, waypoint weather stations to drone pre-flight, departure, en-route and or arrival, any of the above communicating and making decisions with any type of data (such as telemetry data, micro, meso, macro and nano data) being received and shared using ai/ml and blockchain.

In one embodiment, UAVs can be categorized from different perspectives. The categories of UAVs typically focus on its functionality and capabilities. The six most common functionality-based categories applicable to UAVs include: 1) Logistics—UAVs designed for transportation and delivery functions; 2) Reconnaissance—include UAVs performing law enforcement and military intelligence gathering functions; 3) Civil and Commercial—include UAVs designed for commercial applications such as photography and measurement functions; 4) Research and Development—focusing on utilizing existing models of UAVs to test and improve designs of future generation of UAVs; 5) Target and Decoy—providing ground and aerial gunnery a target that simulates an enemy aircraft or missile; 6) Combat—here UAVs are utilized for military missions requiring length pre-attack surveillance and high-risk operations to minimize human casualties.

In some embodiments, the smart landing pad contains a solar energy panel, mailbox flag, strobe light, landing sensors, near field communication (NFC) and the wireless fidelity/wireless internet (Wi-Fi) systems. The solar energy panel, powers all the integral components of the landing pad, making the landing pad, and its integral systems, self sustainable. The landing sensors, assisted by the beacon light and the built-in Wi-Fi system, permit the approaching UAV to autonomously locate the pad and land safely in the center of the platform. The built-in NFC, enables communication between the landing pad and its owners via mobile devices, transmitting to the end users both functional and marketing information.

The landing pad assembly 100 is mounted to the ground utilizing a support tube 102, in accordance with the present invention. The assembly 100 includes, a support tube 102, quick release pin 104, telescoping tube 106, tube to pad adapter 108, landing pad assembly 110, landing sensors 112, beacon lights 114, near field communication (NFC) transmitter/receiver 116, wireless fidelity/wireless internet (Wi-Fi) system 118, solar panel 120, mailbox brackets 122, mailbox flag 124, wall bracket 126 and an optional adapter plate 128. The optional adapter plate 128, which can be utilized to mount the tubing 102, supporting the landing pad assembly 110, directly to any hard surface, including wood or concrete foundations.

The landing pad is embedded with a solar panel 120 designed to provide the assembly 100 with an uninterrupted electrical power. When functional, the landing pad 110 utilizes the imbedded NFC transmitter/receiver 116 and the built-in Wi-Fi 118 systems, to establish the radio data communication with the incoming UAV 200. These systems are designed to guide the incoming UAV 200 to the landing pad 110 utilizing the global positioning system (GPS). Upon approach to the assembly 100, the UAV 200 can rely on the landing pad's 110 built-in lending sensors 112 and the beacon lights 114 to guide it to the final landing position. The entire process is controlled/monitored by the end-user via readily available electronic devices, such smart phones, tables and laptops.

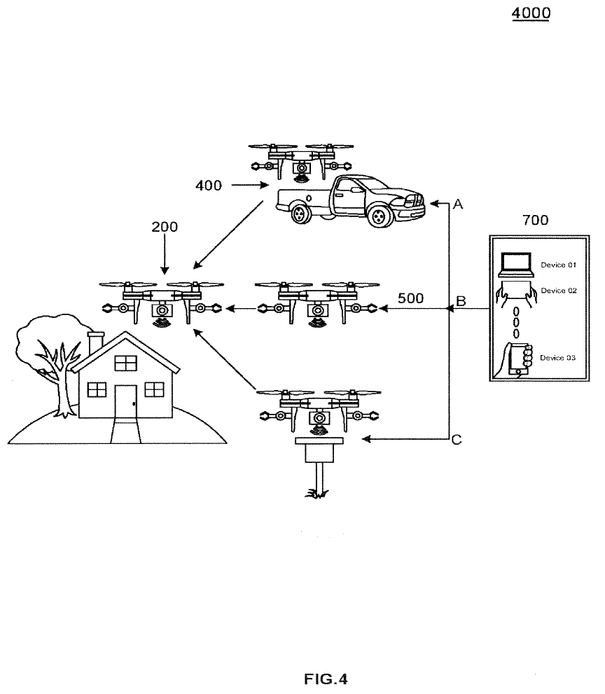

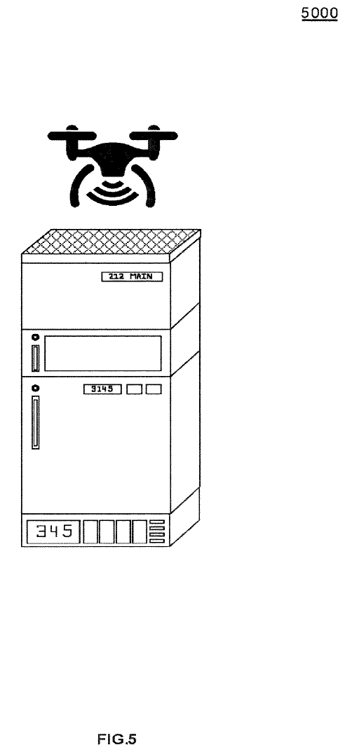

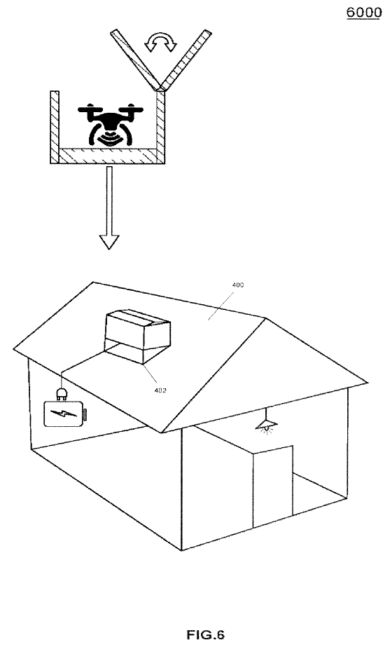

The landing pad 110 can be mounted to a residential or commercial, oval-shaped mailbox, as shown in FIG. 4. Here, the landing pad 110 is securely attached to the mailbox 300 by utilizing two, triangle-shaped mailbox brackets 122. The connection process is completed by attaching to the landing pad 110, a mailbox flag 124. In situations where the residential or commercial mailbox is of rectangular shape 400, shown on FIG. 5, the landing pad 110 can be attached to the mailbox 400 directly, or by utilizing the tube to pad adapter 108,

In some embodiments, there will be a physical doorbell button, a wireless doorbell activation (can be anything wireless like blue-tooth and or short-and long range Wi-Fi, Li-Fi and or frequency hop between networks and the frequency spectrum). The communications and network are agnostic and will have interoperability in the sense that any new and or legacy network can work on it and any software and or specific meta data can be integrated into it using an API, APK, SDK and or Firmware, for example.

In another embodiment, Sensors on the doorbell and chime can range but not be limited to: Insect noise deterrent, rodent noise deterrent, mosquito UV or other light deterrent, bird noise deterrent, chemicals, weather sensors like ambient air, moisture, humidity, rain, due point, smog, fog, light sensors for the time of day, thermal imagery, LiDAR, RADAR, computer vision, AIML, pollination air levels, interior air contaminants, smoke, radiation, and or radon levels as a custom build to suite solution. The doorbell has an emergency/home invasion/help strobe light that blinks when activated by the building occupant, which can also notify local authorities and dispatch. The camera can be used for reading any type of bar codes like QR Codes, shipping codes, delivery codes. The home or business owner can scan this barcode in front of the camera and it will notify the participating and selected shipping company, carrier and or hailing driver or drone service to come pick up a package that is ready. From there, the mobile application can be provided for offering guest one-time purchases and or SaaS service membership levels that provide for available options. Options such as movement activation of the camera. Sound activation that activates the camera and microphone. Video and audio that activates the camera and two-way sound communication with the option to record and memorialize the event. This information can be recorded directly on the SD or similar card (interoperable for storage type) that can be removed from the doorbell for later use or storage. It can also automatically be saved in the cloud database or saved using both methods. If someone is delivering a package they can walk up and the camera and microphone will allow for the customer to see who is at their door from their phone and receive push notifications when a product or service is being used so that the customer is informed in real time and or near real time on their phone if the package was delivered. The doorbell will automatically ring when the driver arrives, drone arrives, and or robot arrives. Any transportation modal can be integrated for 5 this delivery feature. This is for both physical driver and autonomous delivery driver. Family and friend's packages will allow for multiple approved parties to use the service and or accept the packages. Weather reports such as AGL (Above Ground Level), MSL (Mean Sea Level), weather warnings, METARs (Meteorological Aerodrome Reports), TAF (thermal aerodrome forecasts), ice and snow reports, digital twin predictive analytics and life cycle data, metaverse, 3D and 4D GUIs, (graphical user interface) reports, and other information such as autonomous weather performance based certified meta and big data and or supplemental data, can be provided in real time and or near real time at the geo location to both participating parties of delivery and shipment and or other services needing weather information that can range in industry such as for the physical drivers and or autonomous transportation modals such as drones, robots, unmanned ground vehicles and or unmanned marine vehicles (all also known as “uncrewed”). The node centric mesh network can provide situational awareness, deconfliction, sense, detect and avoid solutions, for cooperative and non-cooperative aircraft, ground, and marine modals, for all other transportation modals. Data from this process will be validated as trusted and discoverable data through either public use, private use, and or tier level clearance, using inverted network back and forth decentralized networks, IoT, blockchain, Web3, HTTP, HGTP, Layer 0, Layer 1, state channels, NFTs, smart contracts, metagraphs, DAG protocols, and utility tokens, that can integrate with agnostically with any new and or legacy data and network. This information can be saved and or sold on the Data Exchange by streaming the data in real time and or uploading when preferred to the data exchange for the registration, gifting, donation, remuneration, subsidization, monetization, use, rental, and or sale of the data to other third parties. A materialization and memorialization of all events throughout the ordering process will be recorded. The Smart Delivery Doorbells will be considered nodes. These nodes can discover and add to the existing private network of the user. These nodes will be on the Node Centric Mesh Network. This network will allow for use between the carriers of preference by the shipper and will allow for the delivery choice available at that time based on geo location, weather conditions, availability and type of delivery hardware needed for use. You will be able to hail a drone, driver, robot, eVTOL, VTOL, UGV, vehicle on demand based on your order and payment. You will be able to receive rewards such as loyalty, social, and or carbon footprint rewards, points, coupons, crypto rewards, and or redeemable rebates, for the type of data you offer to any company interested in it.

In another embodiment, if any interested person or entity want to use the meta data of a user smart doorbell, landing pad, charging station, container, drone, drone hanger, and or other participating node, that was recording the whole day and all the cars that drove by, the people and dogs that walked by and the weather throughout the day, you would be able to do so. The user would have loyalty, social, and or carbon credit rewards that would be deposited into your digital wallet selected on the SaaS Delivery Mobile app and or Web3 app that you are a member of. Some services may be free and some may require monthly subscriptions from the SaaS Software. The app will be able to let you know if the delivery arrived and provide other people that are on your family and friend's network information that authorizes them to take the package when you're not home. You will be able to pay for the service through all traditional methods of payments plus crypto and token rewards. NFTs can be made from the pics and of videos for example or Meta data that will be used for future sale if you like or simply stored in your digital wallet.

In another embodiment, The Smart Delivery Doorbell Chime will allow for sensors to be used that can determine the quality of air (so can the doorbell). The type of sensor selected may help with radon, smoke, asthmatic conditions, etc. You can customize the doorbell to have custom assigned multiple chime rings that will allow for you to know who is either ringing at your doorbell and or providing the delivery service.

In another embodiment, the smart doorbell can receive power can be either hardwired, have its own solar power supply and or by battery. There is an LCD, Amoled, OLED technology which comes in PMOLED, Super AMOLED, POLED, (and other variants as well to suit a variety of user needs) Color Screen that will show video, static and dynamic commercials, UI/UX and GUI sensor information such as temperature and customized information based on the use at that time, the time of day, the carrier, company and or product for example. When a driver or drone delivers a package for example, the wireless delivery and or physical QR Code delivery will allow the static and or dynamic advertisement to be left behind on the screen showing the delivery vendor and or product vendor that serviced the delivery order.

In some embodiments, The Smart Doorbell can work with Air Traffic Control, a Drone Operator Ground Control, and any participating hardware (i.e. Node) that can share information and learn from each other. Creating an Artificial Intelligent Machine Learning capability. (AIML) and be able to work under adverse weather conditions. It would be able to be connected to existing security software and hardware or can be used as a security service feature directly through any in house and or Third-Party Company. Tracking numbers can be generated to match the exact carrier of choice. The application allows for our services to be an integrator, validator of data, aggregate of data, rail of data, and market maker of the same data, while also being able to tap into local dispatch for emergencies for example.

In another embodiments, PCB Boards and other third-party software and hardware can use our API, SDK, APK, firmware and open platform interface and operating system for their use. They can also add their own API, SDK, APK, firmware to our open platform interface. Our mobile app will be integrated with the drone delivery of people and cargo so you will be able to use any of our hardware products as auxiliary options that will self-sustain your delivery as a vendor. For example. If you purchase, lease and or use our SaaS service of our Vertiport-in-a-Box (Pending ™) and we repurpose and or build your smart drone rooftop and ground droneport/vertiport/airport, you will be able to provide a true last mile and even last inch at the property logistics from the departure of the fast food restaurants roof to the landing pad that they fill the food in, to the destination of the smart mailbox landing pad, smart landing pad, landing pad, landing pad/charging station by receiving the weather information ahead of the departure that the weather is either conducive for flight of a drone, delivery via autonomous ground robot, vehicle and or only by walk in.

In another embodiment, The doorbell can be used to determine if we will be able to use a fleet of drone, or simply one drone in that area, or for example a driver or robot delivery services using a physical and or Unmanned Traffic Management (UTM) system that will provide for pre-flight weather determination and algorithms to see if delivery is possible and to allow for other variable choices. This information will also help with governing bodies that will use this information to determine safety of flight in that area. Emergency situations, first responders and or crimes can be acted on quickly using the doorbell and chime. Coupons, rewards, incentives can be received, used and redeemed by using the doorbell. The doorbell has a touch screen LCD or other screen selection as well.

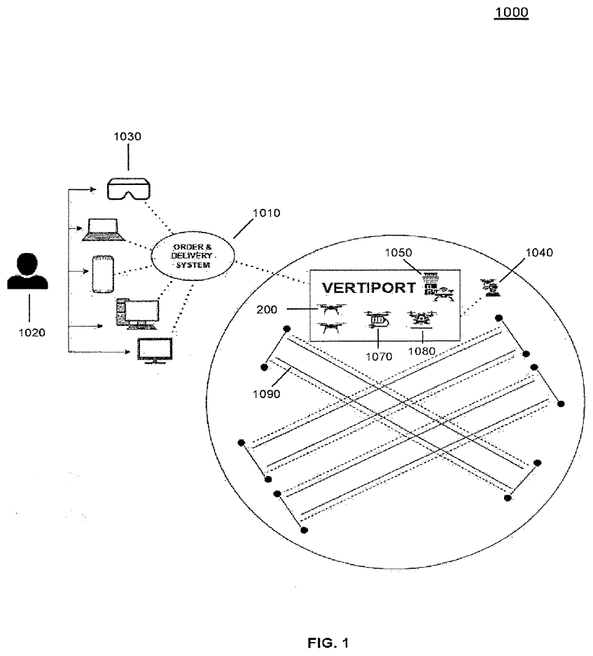

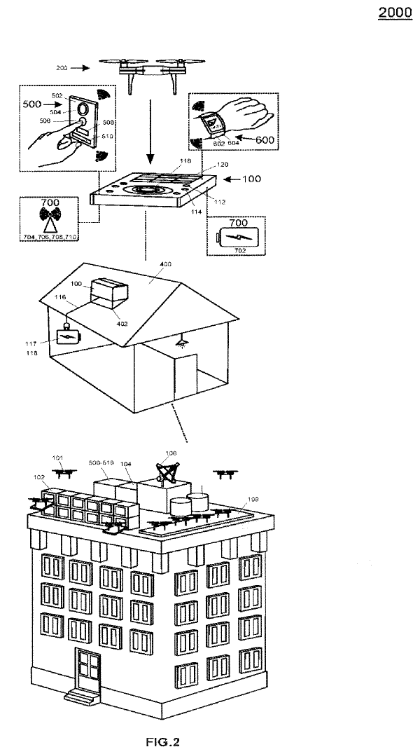

FIG. 1 illustrates a vertiport system 1000 for managing unmanned vehicles in delivering goods or passengers from a source location to a destination location. The user 1020 using the computing device 1030 access a delivery system 1010 in order to get a good delivered to user location. Once the user 1020 places an order for delivery and the Vertiport system 1000 assigns an unmanned vehicle 200 and an unmanned flight planner determines a route considering various factors like distance, weather conditions etc. and shares the same with the unmanned vehicle 200.

In one embodiment, the unmanned vehicle 200 can be controlled virtually using a smart glasses 1040 from any location by the user or a pilot.

In another embodiment, the vertiport system 1000 is equipped with an unmanned vehicle charging station 1070 to charge/recharge the unmanned vehicle 200 when charge in the battery depletes. The charging is done either by replacing the batteries or by charging the batteries present within the unmanned vehicle 200.

In another embodiment, the vertiport system 1000 includes an unmanned vehicle repair station used for repairing the unmanned vehicles when damaged or in daily routine check-up before the unmanned vehicle is assigned a task of delivering a good from one location to other location.

FIG. 2 illustrates notifying system between an unmanned vehicle and various customer devices regarding a package delivery according to the present invention. An unmanned vehicle from a rooftop airport is sent to pick up a good from a source location and travels to a destination location where the unmanned vehicle determines a smart landing pad for dropping the good. The smart landing pad or the unmanned vehicle detects a smart doorbell at the destination location and determines a frequency in which the smart doorbell working and transmits a notification signal regarding the good delivery. The smart landing pad or the unmanned vehicle can detect and connect to the signal of the user smart watch to send a notification signal to the user smart watch regarding the good delivery.

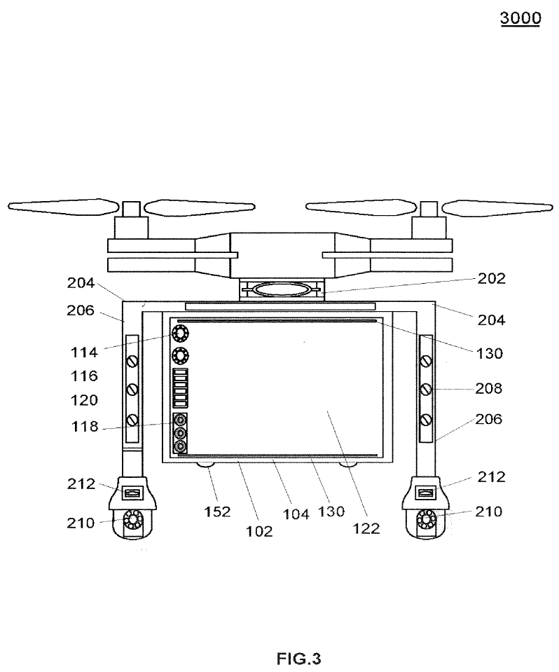

FIG. 3 illustrates an unmanned vehicle carrying a delivery good.

FIG. 4 illustrates a good delivery system through a drone or unmanned vehicle, in accordance with an embodiment of the present invention.

FIG. 5 illustrates a smart mailbox landing pad where the unmanned vehicle drops/picks up a good on to the top of the smart mailbox. The smart mailbox stores the good before the unmanned vehicle is ready for pickup or the user is ready for collecting the delivered good.

FIG. 6 illustrates a smart rooftop landing pad of a house.

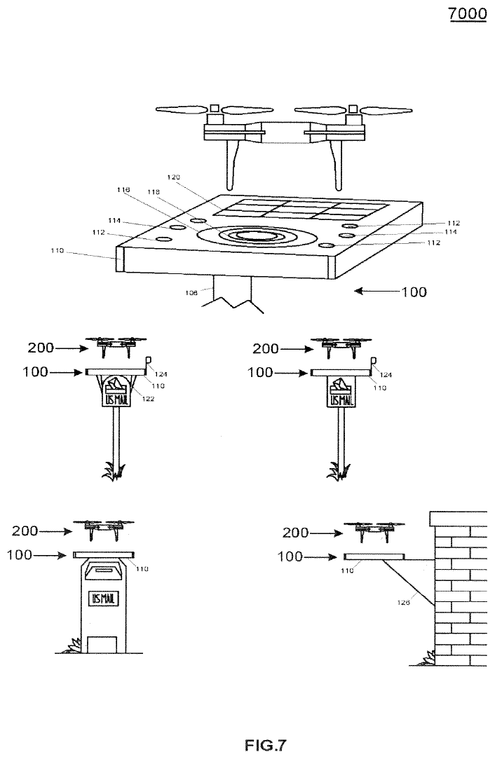

FIG. 7 illustrates smart drone landing pad used by unmanned vehicle during landing/take-off procedures according to the present invention.

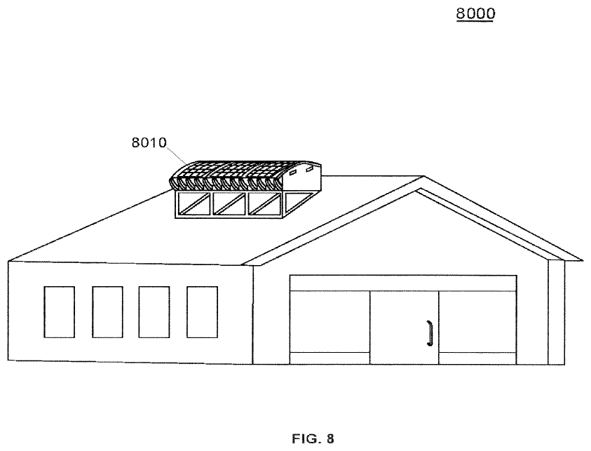

FIG. 8 illustrates a vertiport-in-a-box setup at a house which includes a landing pad/charging pad present within the vertiport box 8010. An unmanned vehicle 200 can fly into the vertiport box 8010 in order to deliver a good.

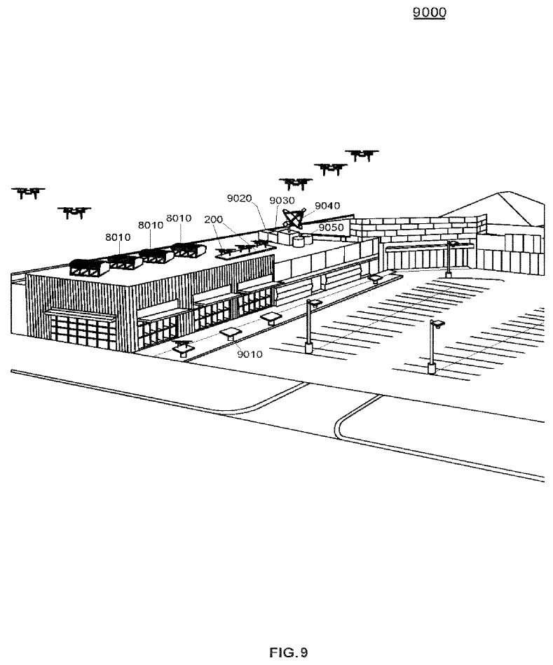

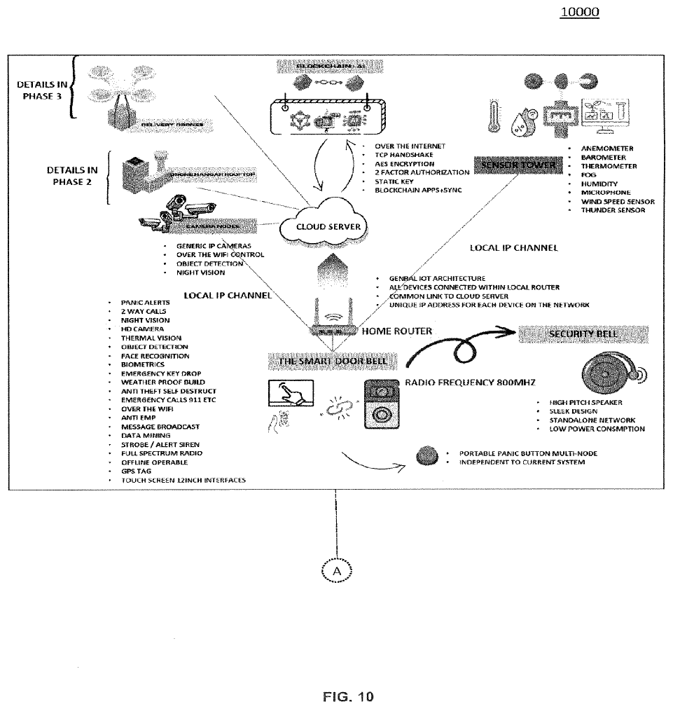

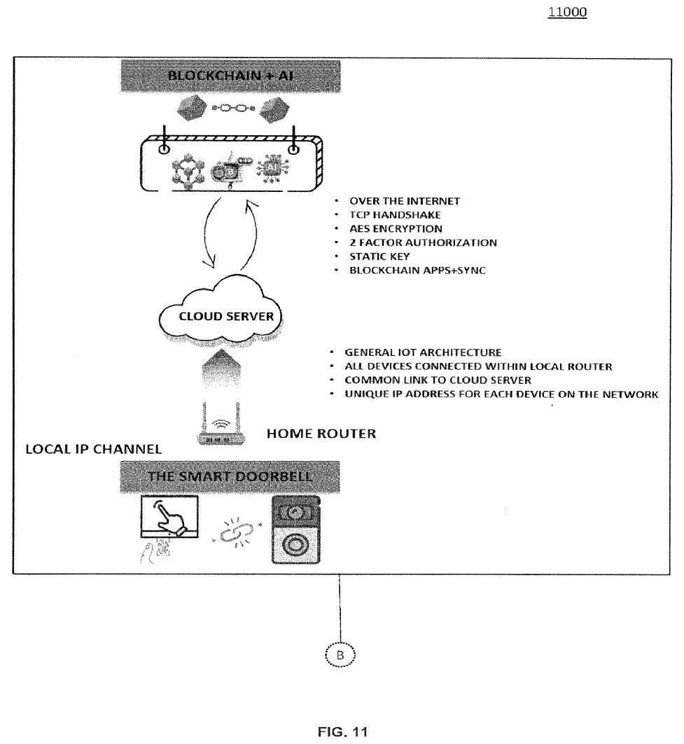

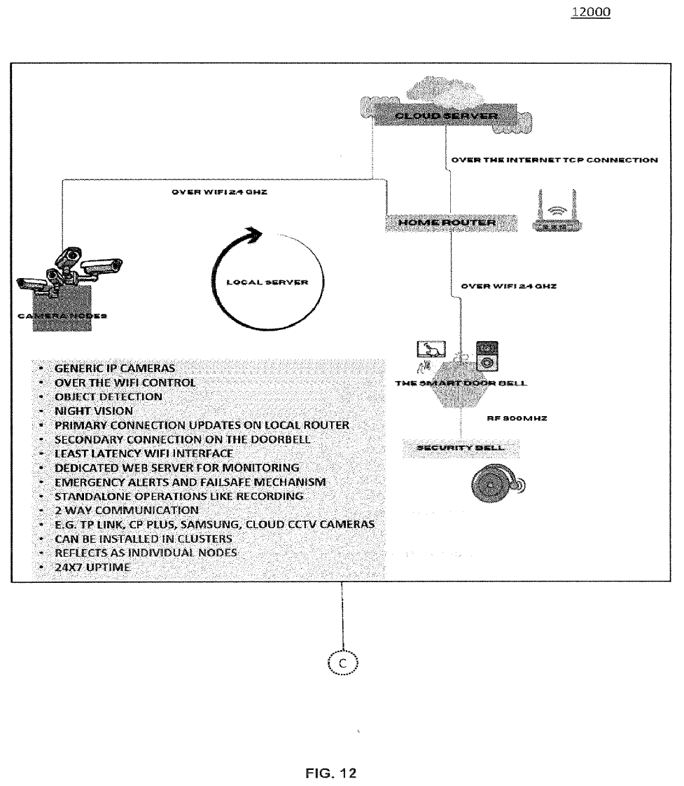

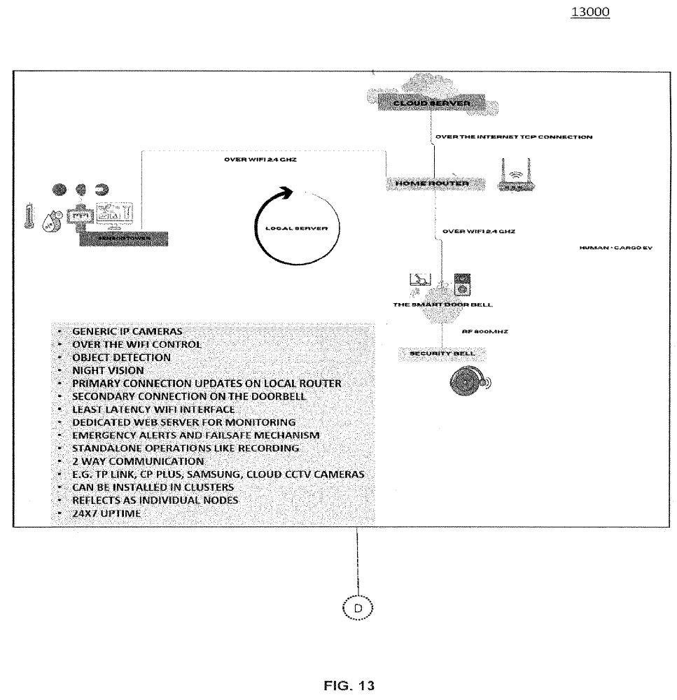

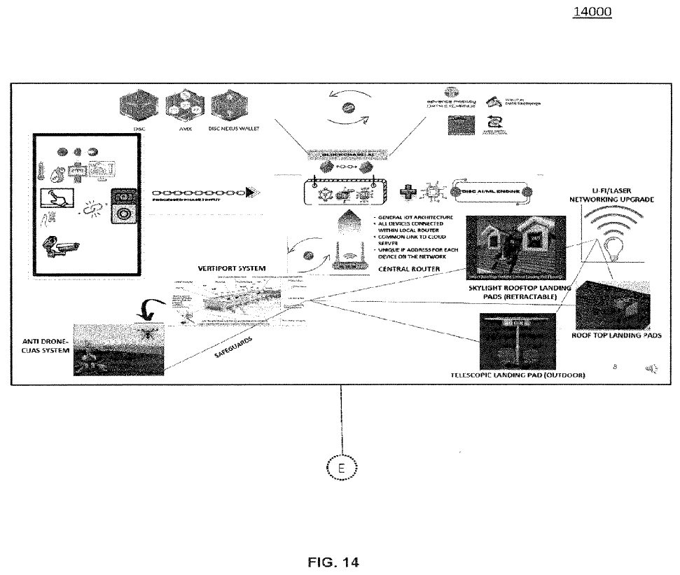

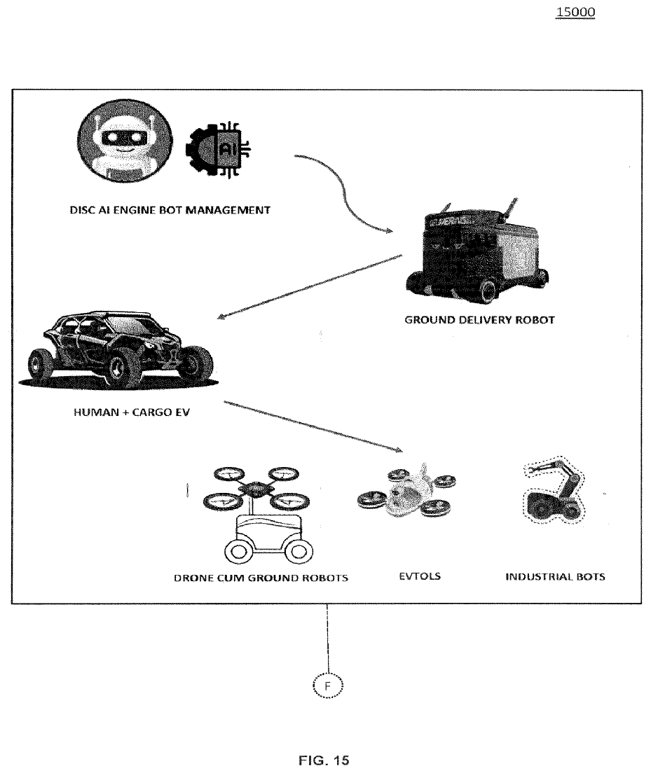

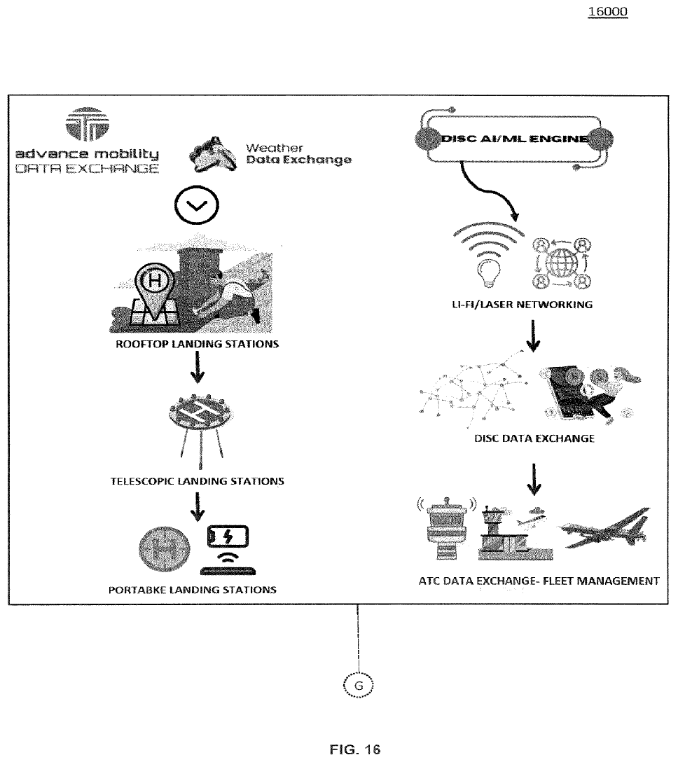

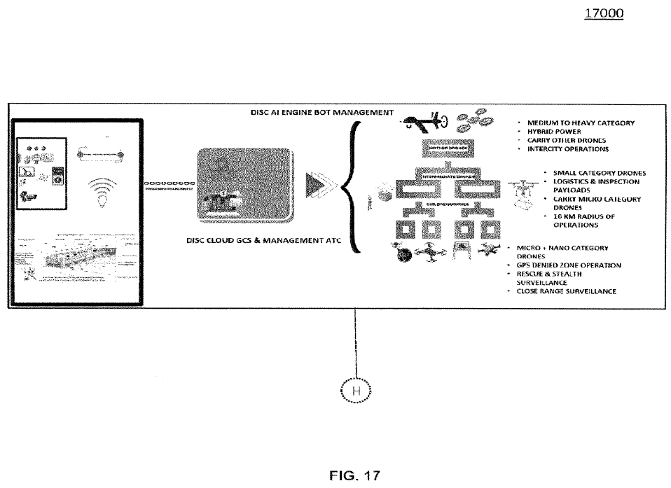

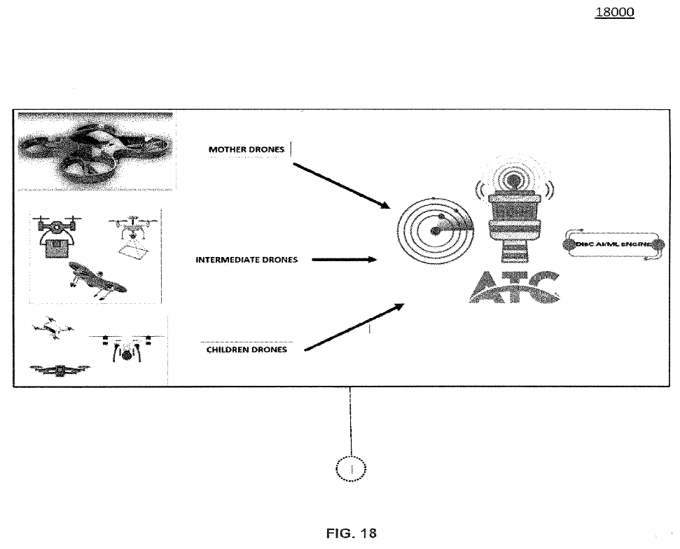

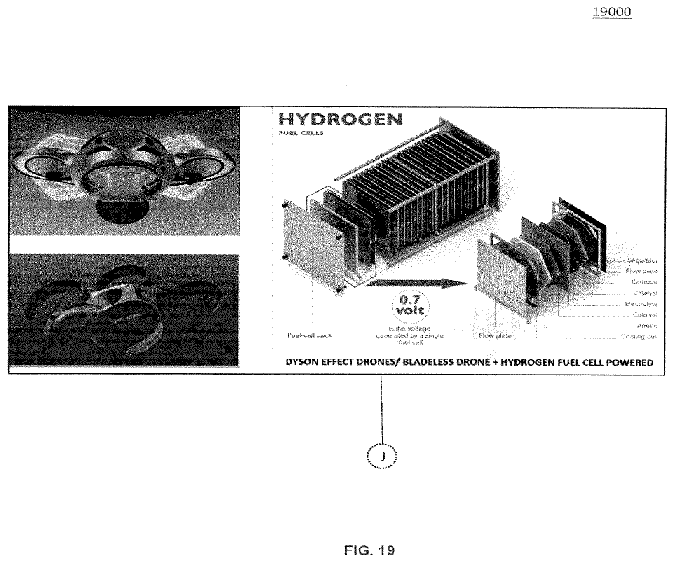

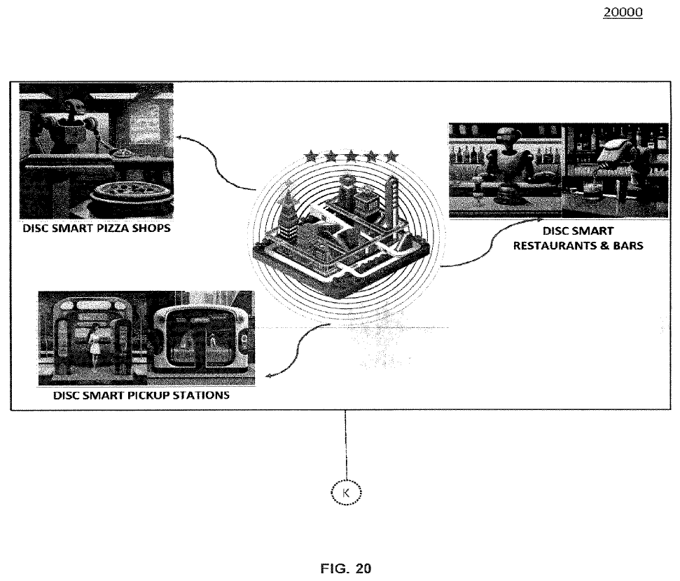

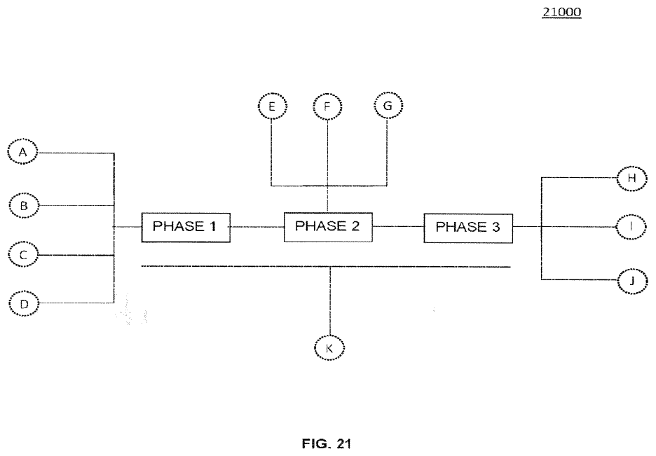

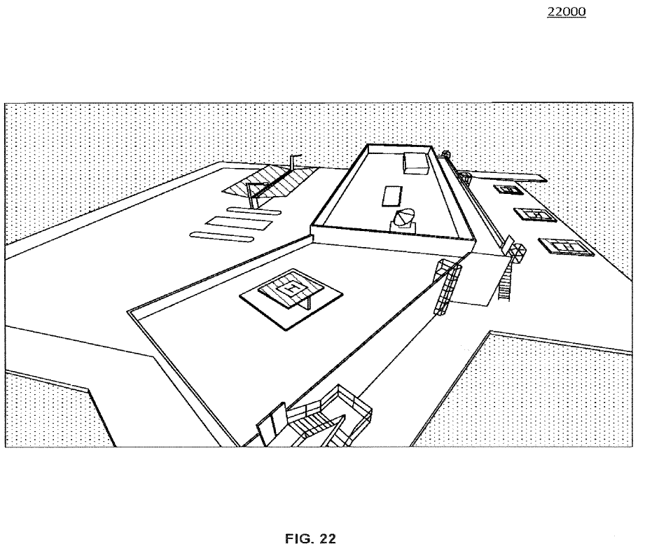

FIG. 9 illustrates a droneport/vertiport system 9000 set up at a private sector wherein the complete system is incorporated into the existing setup. The droneport/vertiport system 9000 includes air traffic control 9040 to control the unmanned vehicles 200 during the delivery operations. Container 9020 for storing a good, a repair station 9030 to repair or maintain the unmanned vehicle 200, an inlet 9050 for entry of the unmanned vehicle 200 directly to a section of the building. Vertiport-in-a-boxes 8010 aligned on top of the building for storing the unmanned vehicles 200 during the delivery task.

In some embodiments, the system includes a drone docking/charging/launching station 100 having components like top cover 101, top solar panel 102, top cover run off channels 103, linear actuator 104, side walls 105, side solar panel 106, side protective material 107, side multiunit clips 108, door 109, door hinges 110, retractable plate 111, landing pad compartment 112, energy convertor drawer 113, portable energy convertor 114, portable battery 115.

In some embodiments, a user application is presented on a smart phone 206 of the user to both control and monitor the functionality of the charging station 100. Utilizing a smart phone 206, the end user will be able to pre-plan the drone's 600 next flight. Once the flight plan is finalized, the application can estimate the minimum level of the drone's 600 battery charge required to reach the pre-planned destination. With a push of a button, the charging station 100 can be directed to begin the process of charging the drone's 600 batteries, and stop when the required minimum level of the battery charge has been reached. The entire process could be monitored by the end-user via the charging station status screen.

In some embodiments, a Smart Doorbell 500 and Smart Watch 600 is a hardware and software node that has both security camera features, push notification features, it turns on when it detects an object moving in front of it. The Smart Watch 600 turns on when the drone 101 has notified the smart doorbell 600 or smart watch 600 that the drone 101 is about to arrive. The Smart Watch 600 also turns on when someone physically walks in front of and or rings the doorbell 506. A user may turn on the Smart Watch 600 if the customer simply wishes to monitor their home for security and or safety. Push notifications can be given while flying over a customer or other third-party mobile app customers and can also provide for static and dynamic commercials and or coupons, incentives and discounts, rebates, crypto rewards, surveys, promotions, and or contests for example.

In another embodiment, the Smart Watch 600 allows for the end user to see the video in real time on their device (mobile or otherwise). The Smart Watch 600 automatically turns off after an end of a user receipt of goods, and end of a user request, receipt of a Smart Drone Request during completion, and/or when the package is no longer in or on the smart landing pad 101.

In another embodiment, The Smart Drone Landing pad and Charging Station 101 also incorporates a smart doorbell video/audio hardware feature that allows for the end user to view and hear the package being delivered via mobile device. This will allow for the recordation, replay, archiving and distribution of the file for each delivery via cloud.

In another embodiment, the Smart Drone Landing pad and Charging Station 101 will communicate with the doorbell to ring the doorbell upon delivery. The OS System will provide pre-notifications to participate in the viewing of the delivery through the doorbell video/audio hardware and well as mobile push notifications to provide an additional form of alert for delivery. The delivery can also be viewed through a smart tv with the option for picture in picture and or Roku.

In another embodiment, the unmanned vehicles can be but not limited to smart drones, autonomous flying devices, autonomous robot devices, autonomous vehicles, autonomous ground robots, autonomous marine vehicles, etc.

In another embodiment, the autonomous flying devices in some embodiments may fly numerous flights making deliveries before being free to return to a base station. Allowing frog leaping from smart rooftop and ground droneport/vertiport/airport, charging stations, and or landing pads. These smart drones may require an ability to find a smart landing pad on numerous locations within its service area in order to deliver items to customers. These smart landing pads provide a secure location to permit the smart drones to land, deliver, and or temporarily store packages, while still having a manual hybrid delivery use and the ability to provide scalability and modulation hardware and software services and applications, with the ability to act as a charging station for the recharge of the unmanned anal vehicle, provide cloud exchange of big and micro data, mining, logging, and recording via blockchain and Internet of Things (IoT).

In another embodiment, the smart landing pad 100 includes a processing node having a processor, memory, a storage device, and a network connection to one or more communications networks, a smart drone landing pad, an induced charging pad configured to recharge a battery within one of the one or more drones, a smart container battery swapping station, one or more external webcams, and a package receiving container for accepting a delivered package.

In another embodiment of the present disclosure, the processing node within the smart drone landing pad downloads mobile applications containing executable instructions for the processor to perform from a 3d party vendor. The cavity of the smart landing pad has the capability to store multiple CPUs, GPUs, Quantum Chips and or multiple blockchains dedicated to each third-party renting the space inside the cavity to allow for their own network, network of nodes, cybersecurity, and or system connectivity.

In another embodiment, the node within the smart drone landing pad communicates with a network controller of the one or more autonomous drones to receive authorization for a particular drone to land.

In another embodiment of the present disclosure, the node within the smart drone landing pad communicates with the particular drone to provide authorization to land.

In another embodiment of the present disclosure, the node within the smart drone landing pad unlocks and opens the access point to permit the delivery of a package.

In another embodiment, the smart drone landing pad 100 or the drone can determine a frequency of the smart door bell and connect to the particular frequency before transmitting a notification to the user.

In one embodiment, the frequency used by the devices in the invention is not limited to 2.4 GHz, 5 GHz, 6 GHz, or 6.5 GHz etc.

In another embodiment, the smart drone landing pad or the drone can ring the smart doorbell without any additional input by connecting to a specific frequency accepted by the smart door bell.

In one embodiment, the node within the smart drone mailbox landing pad provides the current weather conditions to the one or more autonomous drones and the one or more drone service function devices of the drone unmanned system service network.

In another embodiment, the node of the smart drone landing pad further includes a peripheral interface for connecting 3d party devices for use by the node and a blockchain processor of providing a blockchain harvesting, mining, logging, ledger and recording for use with other blockchain harvesting, mining, logging, ledgers, and recording, in other nodes within the drone unmanned system service network to provide a secure and redundant record of all deliveries and autonomous drone flights. This can be used for node clusters to create a consensus of validated trusted data prior to population throughout the blockchain network. Should the proof of observational reputation (POR) show that the characteristics and reputation of the data is not known or out of character, the data would be vaulted for future forensic examination and not be relied upon as trusted data. As the POR of nodes creates a historic reputation of its data on the blockchain network, the data will be scored on its reputation.

In another embodiment, the smart drone landing pad further comprises a hardwire, battery or tritium battery for use when solar panels are not sufficient to support the node of the smart drone mailbox landing pad.

In another embodiment, this invention can be utilized for but not limited to rooftop ports, ground ports, Vertiports, unmanned ports, water ports, drone ports etc.

In some embodiments, the invention can be a Smart AIML Autonomous Infrastructure Vertiport In A Box (VIB) Solution—A Dual-Use Capability

The Smart AIML Vertiport in a Box (VIB) is a rapidly deployable fixed and or mobile decentralized self-sustaining quantum computing digital twin edge solution that offers an inverted closed and or open loop bidirectional Wi-Fi, LiFi and spectrum hopping cloud and edge inverted and back and forth network architectural and compatible hardware that has a transportable dual use light and agile logistical footprint capability, providing both remote and on site Web3 and Extended Reality (XR)/Hyper Reality (HR) and metaverse fleet operations, using a reliable hybrid marine, ground and air, FOB and CB hub and spoke geo mapping node centric and dynamic logistical supply chain and storage, for real time situational awareness and deployment, with the integration of a take-off and landing mobile and modular vertiport pad, combined with a multimodal autonomous marine, terrain, and air solution by integrating marine, ground and air robot and drone hardware nodes, electronic Take Off and Landing Vehicles (eVTOL/ehVTOLs), and its critical infrastructure auxiliaries of hardware, software, weather sensors, meta data crowdsourcing, blockchain and cyber, on a node centric mesh network; to allow for a decentralized multiuse network of smaller, dispersed locations in both a friendly and war theatre environment that is lean, versatile, modular, scalable, sustainable, resilient and horizontally interoperable and agnostic for both legacy and third-party integration. Significantly reducing base setup times while enhancing situational awareness and operational capacity for swift mission executions.
Hardware, Electrical, Communication, and Technology Systems—Key capabilities;
AIML Vertiport in a Box Autonomous System (VIB) (TRL 7-8)
Smart Delivery Doorbell Data Miner (weather sensors, security)
Smart Drone Hanger/Charging Station Data Miner
Smart Drone Landing Pad Data Miner
Smart eVTOL Landing Pad Data Miner
Smart Drone Container/Battery Swapping Data Miner
Smart Ground Robot Data Miner (Modular for use cases)
Smart Drone Data Miner
Smart Nano Drone Data Miner
Smart Weather Tower Data Miner
Smart Armoured Vest with 4 Armed and Deployable Nano Drone Data Miners
GPU Chip at the Edge for each hardware
Decentralized Edge IoT and Node Centric Mesh Layer Zero and Layer One Network
Multispectral AIML LiDAR and RADAR
Environment and Weather Resistant Design
Insects, Pests, birds and Rodent Resistant Sensors
HGTP (Hyper Graph Transfer Protocol), Metagraph, Smart Contracts, State Channels L0 and L1 Networks, Proof of Observational Reputation (POR).
Web3 and Extended Reality (XR)/Hyper Reality (HR) and metaverse fleet operations
Autonomous Mobility Data Exchange (AMX) (TRL 2-3)
Smart Glasses (TRL 1-2)
Smart Lighting (TRL 1-2)
Nano Tech Coating (TRL 1)
Underwater Nano Ultra Sonic GPS Beacon with Marine Mapping Sensors
Air Sanitation Sensor for Bad Actor Air Zone infiltration in No-Fly Zones (TRL 1)
Quantum Processing Chip for at the Edge Computing (TRL 1)
Biometric Security (Audio, Facial) (TRL 5-6)
Advanced AIML Sensors (TRL 7-8)
Spectrum Frequency Hopping (TRL 2-3)
Digital Twinning (TRL 1-2)
Zero Trust Blockchain State Channels and Smart Contract/Ledger (Scalable, Modular, Interoperable, Agnostic) (TRL 5-6)
Self-sustaining Anti-EMP (Hardened), Anti-RF, Anti GPS Scrambling, and Counter-Drone (C-UAS) (TRL 2-3)
Wearable Smart Armoured Vest (Advanced Closed Loop P2P Communications, Shielding Nylon Layer, Anti-EMP, integrated and deployable nano armed drones (TRL 7-8)
Smart Cone (TRL 1) and Blockchain Cyber Security (TRL 7-8)
LiFi (TRL 1-2)
On-board Tritium Micro Power Supply for each integrated hardware that is self-sustaining with a use life beyond 5 years, both during storage and or while in use. (TRL 1)
3D On-demand real time Printer-Precise synthetic and recyclable metal print resolution (TRL 7-8)
Modular and scalable both in hardware and software, as well as data
Closed Loop P2P Communications (TRL 2-3)
Horizontally Interoperable and field repair and replaceable
Durable materials and structures that protect against corrosion, humidity, extreme heat and cold environments, and UV, both during a pre-positioned storage and while deployed.
Underwater Marine Geo Mapping (TRL 2-3)
Smart Nano Scalable Tritium Batteries with self-sustaining charge for 5-20+ years. (TRL 1)
Mechanical Systems—Key capabilities;
Reverse Osmosis Water and Waste filtration system that is scalable and modular for critical biological and mechanical water supply using existing waste and environmental water used to consume, operate, disperse, supply and or survive. (TRL 1)
Uncrewed Marine, Ground and Air Vehicle, and or hybrid autonomous vehicle capable of transporting people and or cargo. (TRL 1)
Autonomous Hybrid Drone Suite: ISR Drone (TRL 7-8), Inspection Drone (TRL 7-8), 4D Projector Mapping Drone (TRL 1), X-ray Drone (TRL 1), DE (Directed Energy) Drone (TRL 1), Delivery Drone (TRL 7-8), Defibrillator Drone (TRL 5-6), Detonate Drone (TRL 1), Mapping Drone, Nano ISR Drone (TRL 7-8), Mother/Child Drone (TRL 1-2)
Modular and Scalable
Interoperable Hardware and remote 3D printer part manufacturing for recycled material and repair
Additive Ground, Air and Space Manufacturing
Recyclable and Indigenous Material for Landing Pads/Tarp Repair and Replacements as well as integration and operation. Terraform materials with modular and scalable sensors.
Base Infrastructure
Integrated Base Security, Response & Recovery
Value Proposition: How your solution can benefit the USAF.
Primary: Demonstrate the viability of a Vertiport in a Box (VIB) solution that will streamline and expedite the planning and setup of operations using available resources to erect, construct, install, and repair expedient facilities and critical infrastructure in austere, remote, and isolated locations and environments, using a decentralized and distributed hub and spoke operations system for rapid and reduced USAF response to a humanitarian crisis, natural disaster and or military activity in hostile environments that are lean, versatile, modular, scalable, sustainable, resilient, and horizontally interoperable and agnostic between forces that will address essential infrastructure to support military operations and contingency missions as an Agile Combat Employment (ACE).
Secondary: to accelerate VIB concept of operation technology development for operational adoption of advanced capabilities by the U.S. Government.
Smart AIML VIB is self-sustaining. A rooftop and ground location can be used to demonstrate operations.
Note: Any government legacy software, operational hardware, commas, cyber and or sensor integration requests will require any integration requirements for implementation.
Hardware, Electrical, Communication, and Technology Systems—Key capabilities;
AIML Vertiport in a Box Autonomous System (VIB) (TRL 7-8)
Smart Delivery Doorbell Data Miner (weather sensors, security)
Smart Drone Hanger/Charging Station Data Miner
Smart Drone Landing Pad Data Miner
Smart eVTOL Landing Pad Data Miner
Smart Drone Container/Battery Swapping Data Miner
Smart Ground Robot Data Miner (Modular for use cases)
Smart Drone Data Miner
Smart Nano Drone Data Miner
Smart Weather Tower Data Miner
Smart Armoured Vest with 4 Armed and Deployable Nano Drone Data Miners
GPU Chip at the Edge for each hardware
Decentralized Edge IoT and Node Centric Mesh Layer Zero and Layer One Network
Multispectral AIML LiDAR and RADA
Object sense, detect and avoid, deconfliction, cooperating, non-cooperating eVTOL, UAS, UAM, UAG, nodes.
Environment and Weather Resistant Design
Insects, Pests, birds and Rodent Resistant Sensors
HGTP (Hyper Graph Transfer Protocol), Smart Contracts, State Channels L0 and L1 Networks.
Web3 and Extended Reality (XR)/Hyper Reality (HR) and metaverse fleet operations
Autonomous Mobility Data Exchange (AMX) (TRL 2-3)
Smart Glasses and Oculus (TRL 1-2)
Smart Lighting (TRL 1-2)
Nano Tech Coating (TRL 1)
Underwater Nano Ultra Sonic GPS Beacon with Marine Mapping Sensors
Air Sanitation Sensor for Bad Actor Air Zone infiltration in No Fly Zones (TRL 1)
Quantum Processing Chip for at the Edge Computing (TRL 1)
Biometric Security (Audio, Facial) (TRL 5-6)
Advanced AIML Sensors (TRL 7-8)
Spectrum Frequency Hopping (TRL 2-3)
Digital Twinning, Predictive Analytics and Life Cycles (TRL 1-2)
Zero Trust Blockchain State Channels and Smart Contract/Ledger (Scalable, Modular, Interoperable, Agnostic), Proof of Observational Reputation, Data Validation, Consensus, Node Cluster, Metagraph, HGTP, Web3, Inverted Decentralized Node Centric Mesh Network (TRL 5-6)
Web3 and Extended Reality (XR)/Hyper Reality (HR) Fleet Operations (TRL 1-2)
Self-sustaining Anti-EMP (Hardened), Anti-RF, Anti GPS Scrambling, and Counter-Drone (C-UAS) (TRL 2-3)
Wearable Smart Armoured Vest (Advanced Closed Loop P2P Communications, Shielding Nylon Layer, Anti-EMP, integrated and deployable nano armed drones (TRL 7-8)
Smart Cone (TRL 1) and Blockchain Cyber Security (TRL 7-8)
Wi-Fi, LiFi and full spectrum frequency hopping (TRL 1-2)
On-board Micro Power Supply for each integrated hardware that is self-sustaining with a use life beyond 5 years, both during storage and or while in use. (TRL 1)
3D Printer—Precise synthetic and recyclable metal print resolution (TRL 7-8)
Modular and scalable both in hardware and software, as well as data
Closed Loop and Open Platform Option for P2P Communications (TRL 2-3)
Horizontally Interoperable and field repair and replaceable
Durable materials and structures that protect against corrosion, humidity, extreme heat and cold environments, and UV, both during a pre-positioned storage and while deployed.
Underwater Marine Geo Mapping (TRL 2-3)
Smart Nano Scalable Batteries with self-sustaining charge for 5-20+ years. (TRL 1)
Mechanical Systems—Key capabilities
Reverse Osmosis Water and Waste filtration system that is scalable and modular for critical biological and mechanical water supply using existing waste and environmental water used to consume, operate, disperse, supply and or survive. (TRL 1)
Uncrewed Marine, Ground and Air Vehicle, capable of transporting people and or cargo. (TRL 1)
Autonomous Hybrid Drone Suite: ISR Drone (TRL 7-8), Inspection Drone (TRL 7-8), 4D Projector Mapping Drone (TRL 1), X-ray Drone (TRL 1), DE (Directed Energy) Drone (TRL 1), Delivery Drone (TRL 7-8), Defibrillator Drone (TRL 5-6), Detonate Drone (TRL 1), Mapping Drone, Nano ISR Drone (TRL 7-8), Mother/Child Drone (TRL 1-2)
Modular and Scalable
Interoperable Hardware and remote 3D real time printer part manufacturing for recycled material and repair
Additive Ground, Air, Space and Marine Manufacturing
Recyclable and Indigenous Material for Landing Pads/Tarp Repair and Replacements as well as integration and operation.

The smart doorbell according to the invention is a combination of an inside doorbell and an outside doorbell. The inside doorbell and the outside doorbell consist of multiple similar sensors. Also, an amber alert and 911 home invasion/emergency flashing light is equipped on the outside doorbell.

All the smart devices including the smart landing pad, smart doorbell, smart chimer allow the customer to opt into meta data sharing and they get to choose which data they want to share in exchange for crypto security and or utility rewards.

The present invention allows the user to opt into allowing drones and eVTOLs to fly over their private home. This also applies to a Smart Rooftop Weather tower that will have two lights (red and green) to allow the drone to know through AIML Computer Vision that the private home is allowing (green) or not allowing (red) the drone to fly over the private home. This allows a frictionless participation relationship for obtaining air rights over private property autonomously.

The outside light on the doorbell is a flashing strobe light which is a distress call. It will call 911 and dispatch automatically and it is connecting to the local authorities

In one embodiment, the unmanned vehicle is controlled by a remote pilot using a smart glass, wherein the smart glasses will be the first to have AIML auto vision correction. Which can change the frames over and over but will never have to change the prescription in the lenses ever again. It will have OpenAI/ChatGTP and be on the blockchain with biometric security.

The Smart Doorbell, drone and container, ground robot and eVTOL, all allow advertisers to place static and or dynamic ads on the LCD or other screen.

When a shipping carrier comes by to deliver a product, the doorbell can scan the barcode and leave a commercial of the shopping carrier that made the delivery. The chime can have download ring tones that can be assigned to each carrier.

The Smart Delivery Doorbell Data Miner and other auxiliaries for the System such as the landing pad, drone, ground robot, etc., can be sold with a SaaS system service, as a decentralized data validator system where someone becomes a datarepreneur and mines and owns the mined data as a data miner and or data validator and then sells and or negotiates dynamically terms and conditions that are custom and agreed to by the parties, which is done on a data exchange, etc., and or as a hardware and SaaS package solution that allows someone else to manage the operations. A static NFR (Non-Fungible Right) and or NFT (Non-Fungible Token) will be created once the dynamic terms and conditions on the data exchange have been fully agreed to and paid. A service fee for the exchange service for discoverable trusted data that can be queried negotiated and smart contracted will be assessed for the services that are given rights via the NFRs. This is the trifecta. Validated trusted data that is discoverable, and rights driven via the digital data bundle of rights DDBR and NFR. Accumulative decentralized and validated data can be used and owned by the data exchange by various participants that provide genesis created data on the exchange for acquisition/users.

The Smart unmanned delivery system includes but not limited to Smart Data Mining, AIML, OpenGTP, HGTP, L0 & L1 layer security, Smart Contracts, State Channels, Metagraph, Metaverse, VR, AR, MX, XR, HX, nodes, Node Centric Mesh Network, Crypto/Utility Token Rewards ($DISC), Autonomous Mobility Data Exchange ($AMX), Inverted decentralized Network Architecture (backward and forward compatibility), Quantum Computing, Solar, Metaverse ecommerce (M-Commerce, Web3, QR AR Code, Multimodal hailing app, eVTOL, ehVTOL, ground drone robot, UGV, UMV, drones, UMV, LiFi, and participating node auxiliaries.

In one embodiment, The Vertiport-in-a-Box (VIB)© solution allows us to repurpose existing rooftops and ground structures and land to integrate custom use case partners that provide autonomous hardware for air, ground and marine vehicles and software data sensors using our Node application.

In some embodiments, users or consumers, drone service operators, sensor data suppliers, users and asset owners should have the right to own their surrounding airspace metadata they can produce from their smart phone apps, consumer owned vehicle and home sensors and be able to receive rewards and or compensation for that information if they elect to sell that data.

In some embodiment, you will be able to integrate a Smart Mailbox Landing Pad™ into an existing shipping logistics infrastructure that can provide point to point blockchain validated AIML edge computing and point to cloud communications. By offering Smart Mailbox Landing Pads™ you are creating at your destination, delivery waypoints for customers.

The present invention provides various solutions like but not limited to:
DISC's acts as a manufacturer and or OEM and or reseller of its autonomous Drone Vertiport-in-a-Box (VIP) system by offering its infrastructure, inspection, restaurant and retail customers an ala cart menu of third-party manufacturers based on use case that can be integrated into our multi-modal autonomous drone and vehicle delivery open mobile and network platform that is scalable, modular, and interoperable.
Allowing for both the customer and any qualified third-party autonomous drone and or vehicle manufacturer to both support the integration as a deployable hardware into both DISC's autonomous delivery marketplace and into the customer's existing POS and delivery platform system, using DISCs onboarding and integration services.
Existing and future drone delivery and other industry specific third-party companies will have a marketplace through DISC, to find drone delivery operation services that are needed, without the necessity to operate and maintain a customer acquisition structure.
Autonomous drone and vehicle delivery services will be safer, faster, fresher, and more sanitary the less the human factor is introduced into the delivery model's cycle. Companies do not need to worry about high driver staff turnover.
   Smart Kitchens will be integrated where fully autonomous kitchens will have kitchen cooks, bartenders, servers, and or prep robots that can fully automate the food preparation and or shopping selection that will move into the autonomous multimodal delivery stages.
Autonomous drones and its delivery system can avoid typical traffic bottlenecks, stop lights, tickets, long refuelling down times by flying as the crow flies from point A to point B.
Autonomous drones and vehicles do not need to be paid a commission for its delivery on top of its delivery service fee. This means more retail and higher ticket sales for the restaurant, retailer, and the State taxing body.
True Last Mile and Last inch Logistics© via autonomous drone has the option to start its departure right from the restaurant and retailer facility roof or ground location, making delivery faster and avoiding less than load (LTL) delivery time waste and costly transfers of transportation costs.
Customers will be able to choose between the types of transportation available from the vendor for their orders. Such as bicycle, manual vehicles, autonomous vehicles, autonomous air taxis, ground robots, or simply pick-up. The customer will be able to choose the available transportation and pay for the convenience it offers. Customers can schedule and hop between multimodal transportation solutions for people and or cargo to be able to be delivered autonomously.
Autonomous delivery times are predictable, transparent, reliable, and sanitary.
Autonomous delivery provides for shorter time delivery cycles, providing for increased Gross Transaction Value (GTV)
Vacant worthless roofs tops provide for a far less expensive infrastructure integration by layering the customer's drone delivery system using DISCs Drone Rooftop and Ground Airport, right at the restaurant or retail building structure.
The Smart Delivery Drone Marketplace allows for all third-party drone and vehicle delivery services to participate as Delivery Service Providers.
   DISC is creating a solution for this data to be decentralized from government services as discoverable by way of DISC's AMX Data Exchange(s). To succeed in the execution of this disruptive model, the use of data must be discoverable on a market maker exchange. It must be trusted data with integrity that is immutable and meeting all government requirements and governing rules, as they scale, change and or adapt to market needs. You must be able to track the chain of custody of the data to memorialize the events from its genesis creation. The data must be able to be repurposed, subsidized, and monetized on a Data Exchange or Data Exchanges that are data and hardware agnostic, and can provide for data integrity, be cross-exchange data and token compatible, to be available as a data on demand, being offered on any of the Exchange(s) as a multi-exchange data repository.

In one embodiment, the present invention is part of an entity named Drone Industry Systems Corporation (DISC). DISC has discovered additional problems that can be solved with one solution. DISC's Smart Self-Healing Node Centric Blockchain Open Platform and Interoperable Autonomous Infrastructure system, is designed using the Constellation Network HGTP horizontal Hypergraph protocol, Directed Acyclic Graph (DAG), State Channels, and the Stargazer Digital Wallet and DISC Nexus Wallet integrated system that can be mined, node consensus validated using Proof of Reputation (PRO), which will be encrypted, logged, and memorialized, using the data for near real time, real time, sub-real time and or future historic AIML use. The system is scalable and agnostic to any network such as Blockchain, Etherum and Avax. This allows for participating sensor companies and autonomous delivery operators to be able to receive trusted integrity data that is compliant, reliable, and specific to their mission, operation and or use case.

DISC will fill these gaps by becoming the ASTM and Cyber Security integrator for autonomous operations and the sensor data aggregator and railed data receiver/supplier for Validated Data Suppliers and Acquisition Data Users on our AMX Exchange and Sub-Exchange(s) for data that is discoverable, trusted integrity data that can be used as either raw, layer modelled, and or NFT and or NFR data that can be monetized and between buyers and sellers.

To achieve these objectives, DISC has created the first of its kind Autonomous Mobility Data Exchange (AMX) and its beginning Sub Exchanges: Advanced Mobility Data Exchange, the Weather Data Exchange, Utility Data Exchange, Military Data Exchange, and the Smart Delivery Data Exchange as its first of its many industry specific Data Exchanges to be introduced where you will be able to actually download data from the exchange.

The Autonomous Mobility Data Exchange and its key intro Sub-Exchanges; Advanced Mobility Data Exchange, Weather Data Exchange, and the Smart Delivery Data Exchange, are decentralized dynamic, remote, mobile, stand-by data, weather data, telemetry, digital twinning, predictive life cycles and analytics, and drone/VTOL delivery data auction exchange(s) for autonomous Drone and VTOL infrastructure live data, historic raw data, and data modelling, built on world class blockchain technology by developing a hosted state channel, smart contract and megagraph HGTP Web3 decentralized and centralized AMX.

AMX is the application that will host a risk and performance based immutable critical weather, telemetry, and infrastructure data exchange in near to real-time, consisting of a self-healing node centric mesh network of participating sensor data suppliers. Providing for cost effective data distribution with all participating sensor data stakeholders in the autonomous Drone and VTOL industry.

This critical and verified raw, live and or pre-modelled data will be blockchain validated, encrypted, and modelled using shared and daisy chain edge and IoT backward and forward inverted data, processing and computing for regulated and tiered level autonomous use cases and missions, based on risk, performance and reliability certification data criteria that applies to specific autonomous preflight and ground operation authorizations.

By DISC leveraging agnostic network on the Constellation's network and independent networks like Bitcoin, Etherum, and Avax, for example, we can provide data assurance using blockchain technology built for an immutability, security, auditability, traceability, scalability, and speed under a feeless peer-to-peer network that supports L_0 state channels powered by the DAG (directed acyclic graph) utility. Based on a decentralized protocol HGTP that allows for programmatic, automated, and immutable business logic. The Constellation network allows for gasless fees for crypto and token transactions, making the network faster, more scalable and with less latency and more affordability than any other network. This does not stop the use of other networks without Constellation which will incur gas fees when data transfers between networks.

In one embodiment, the present invention also provides a solution which includes various steps:
One example of how a use case process works, can be demonstrated in the bullet points below:
Onboarded Strategic Hardware Manufacturer Partners are integrated with our node on our smart node centric operating system. for direct edge computing.
Sensor Data Suppliers supply data using their sensors through our direct node point to point and or point to cloud services. This data can be used with their own operations related to a fleet of drones, drone customers and or sensors.
Consumer retail or food end-user orders come in from DISC's Smart Delivery Drone Mobile App and DISCs Nexus Digital Wallet on their mobile phone.
The order is processed using the end-user's mobile device or online.
Blockchain origination begins on the end-user side of the participating app user.
Blockchain origination begins as participating drones, landing pads, charging stations, droneports, drone hangers, drone containers, point of sale (POS) hardware, and other participating auxiliaries that are being used in the storage, charging, departing, enroute and or arriving operations, which use sensor payloads on the edge (point) of the network, to begin the sensor data blockchain validation process of planning, approving and executing the operational delivery objective.
On the point-to-point side of the hardware, artificial intelligence, and machine learning (AIML) allow for all participating nodes (hardware) to edge compute and communicate with each other to share and learn information that is mission critical. This information can be weather conditions, object detection, and or hardware heath, to name a few. Data that needs to go through the cloud will go directly to the operators and or vendors and or bifurcate to the Data Exchange. This information allows for beyond visual line of site (BVLOS), through situational awareness, autonomous decision-making, sensing, detecting and avoiding objects, deconfliction, and adverse weather avoidance, minimize grounding of operations and turn-key operational fulfilment.
Alternatively, an end-user can use DISC's Smart Mailbox Landing Pad and order on its digital touch screen interface between any of the competing shipping carrier delivery services such as USPS, FedEx, UPS, and or DHL.
During this process, participating strategic partners and stakeholders can opt in to having the data bifurcated into near real time streaming or placed in our repository to be sold on one of our Data Exchanges.
   Data End-users can now go to the specific Data Exchange of interest and purchase, lease, license, use and or reuse the data for their own specific use case or purpose.

In one embodiment, Sensor Validated Data Mining Hardware and NFTs: As data sensor auxiliaries add to the network, nodes and cyber inflation requires more data and data processing at the edge for situational awareness. Node data miner's such as the smart delivery doorbell miner, the smart landing pad data miner, and other data miner solutions will provide for validated trusted blockchain data that will be able to create NFTs and or NFRs that can be sold on the AMX Exchange after providing the data validator crypto rewards for their data.

In one embodiment, DISC can take an end user's B to B and or B to C use case and provide a VIB solution by designing a rooftop floor plan. For example, using the above floorplan allow for one stand-by public defibrillator drone, one stand-by AMBER Alert drone, full spectrum frequency hopping, one stand-by first responder drone, one stand-by inspection drone, five stand-by delivery drones, five charging stations, six droneports, various positioned critical data sensors, one satellite, one LiDAR, one RADAR, various airport/vertiport lights, ten inhouse and public use drone parking and storing hangers that can be rented and or shared with dedicated news outlets, law enforcement and or medical delivery services, and one anti-EMP sensor.

### Mining, Blockchain Validating, Monetizing of Data

Discoverable data for end users such as drone operators, industry analysts, universities, aviators, meteorologists, scientists, public and private sector data acquisition companies, construction, real estate companies, municipalities, legal entities, law enforcement, military and even just someone who simply would like to know the daily weather on their smart phone, to name a few, has been trapped in centralized government, institution, and industry specific sectors that are either unknown or not discoverable to other market sectors as being trusted validated reliable integrity data that is available for purchase, lease, license, use, and or reuse. Most used data is purged, dumped, deleted and or stored for historic memorialization because it either has no specific use other than what it was intended for from its inception, it is too costly to store if it has no further purpose, there is no place they know where to market the data, the data has a specific shelf life, the information is confidential or classified and the owner doesn't know when it will be declassified or if they can repurpose the specific data they are able and willing to sell, and or the data is not verifiable and therefore not a reliable as data with integrity, resilient, and immutable that can be tracked to its geneses source, giving little to no value to the end user who might want to purchase the data or to the data supplier who put the sweat into originating the data who deserves to be paid for its labor.

### Blockchain Validated Data as a Service

DISC's purpose is to mine, validate and monetize raw, modeled, and co-op modeled data. We introduce the concept of “repurposing of data” on our decentralized subject specific discoverable data exchange(s) that will allow for Data Suppliers and Data Users to have a go to data market where they can query and purchase and or lease specific data on a discoverable data exchange, that they can rely on as validated. Chain of custody of the data via blockchain allows data suppliers and stakeholders to be compensated for the data they have put through our Blockchain Validation Data as a Service (BVDaaS) interoperable open platform data exchange model.

### Blockchain Validated Data Storage as a Service

Data will need to be stored by either depository and or repository methods. DISC will provide data storage after the blockchain validation process for data to be discoverable as trusted data on one or many of our Data Exchanges.

Directed Acyclic Graph (DAG) as a Service (DAGaaS)©: This HGTP Hypergraph Network verification process and the Metagraph is the differentiating cost and speed benefit of DAG vs Blockchain. This service allows for the verification process to be asynchronous in near real time or real time and lower latency, along with low computing power that leads to zero to low-cost fees, in addition to not requiring a minor in an asynchronous genesis node transaction and verification. DISC will provide the services to help onboard Data Supplier with Data Users in with trusted validated data at a more reliable, cost effective and efficient method than traditional distributed ledger Blockchain methods. DISC can integrate the blockchain transaction and smart contract and state channel transactions that can be transitioned as its last bock, into the first genesis node transaction for the first DAG transaction through the Proof of Observational Reputation (PoR). Or it can simply generate the first genesis DAG node transaction, where the entire chain will be connected horizontally from the time of creation.

### Data Market Maker as a Service (DMMaaS)©

DISC is creating a market as the market maker for Data Supplier and Data Acquisition User via DISC's Data specific Exchange(s). Data Suppliers will be able to place their blockchain validated data on the Data Exchange or Exchanges they wish to market their data on. Here is where Data Acquisition Users will be able to purchase, lease, license, use, reuse and or receive for gift or free this discoverable data. By simply providing a query request of a key word or words that the Data Supplier set up in its back-office dashboard account, the end-user can discover trusted data that has been validated through the Constellation Network's Node Consensus system on the L-0 (Level Zero) network layer.

### Autonomous Infrastructure Environmental, Social, and Governance (ESG)©

Vendors, Operators and Customers can be rewarded for participating in ESG via Token/Crypto Rewards. When an electric car, drone, robot and or social benefit creates a smaller carbon credit footprint, crypto rewards and social rewards are a way to recognize and support that evolution into a cleaner and more sustainable solution.

DISC has created a turnkey autonomous delivery infrastructure system of systems by repurposing existing infrastructure and data through the steps of mining, cyber secure data validating and providing monetization solutions, so that it has positioned itself through its VIB solution to be the relied upon open platform system as the autonomous interoperable integrator of hardware and software, the aggregator of participating sensor data suppliers, with discoverable integrity data to the participating end users, as a market maker of trusted, monetized and rewarded data, through our data exchanges.

In some embodiment, a user or an entity can see through the smart delivery doorbell and other data miner cameras through the metaverse into the real world in order to see real weather and security through the metaverse.

The system explained herein can be a computer system and the computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, system memory, and bus that couples various system components including system memory to processor. Processor may include software module that performs the methods described herein. The module may be programmed into the integrated circuits of processor, or loaded from memory, storage device, or network or combinations thereof.

Bus may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus. Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory can include computer system readable media in the form of volatile memory, such as random access memory (RAM) and/or cache memory or others. Computer system may further include other removable/non-removable volatile/non-volatile computer system storage media. By way of example only, storage device can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/output (I/O) interfaces.

Computer system can communicate with one or more networks such as a local area network (LAN), a general wide area network (WAN), LiFi and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Aspects of the present disclosure are described with reference to flowchart illustrations and/or block diagrams of methods, apparatus (systems) and computer program products according to some embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

The present invention may be embodied in other specific forms without departing from its spirit or essential characteristics. The described embodiments are to be considered in all respects only as illustrative and not restrictive. The scope of the invention is, therefore, indicated by appended claims rather than by the foregoing description. All changes which come within the meaning and range of equivalency of the claims are to be embraced within their scope.

I/We claim:

1. A vertiport system, comprising:
a. a plurality of unmanned vehicles for delivering a good from a source location to a destination location,
wherein a unmanned vehicle flight planner is configured to select one of the plurality of unmanned vehicles and send a flight itinerary to deliver a good from the source location to the destination location;
b. a charging station for charging the unmanned vehicle based on the determination of the depletion of charge level of the unmanned vehicle;
c. A repair station for repairing the unmanned vehicle; and
d. a vertiport-in-a-box at the destination location for receiving the good of a user from the unmanned vehicle on to a smart landing pad within the vertiport-in-a-box, wherein the smart landing pad determines a frequency of the smart doorbell and connects to the smart doorbell for generating a delivery notification to the user by ringing the smart doorbell.

2. The system of claim 1, wherein, the user can collect the good from the unmanned vehicle after going through an authentication process,
Wherein, the authentication process includes but not limited to receiving a biometric authentication, pin code etc. from the user.

3. The system of claim 1, wherein the smart landing pad further comprises:
a node having a processor, memory, a storage device, and a network connection to one or more communications networks;
a drone landing pad;
an induced charging pad configured to recharge a battery within one of the one or more drones;
one or more external webcams; and
a package receiving area for accepting a delivered good.

4. The system of claim 1, wherein the smart landing pad further comprises:
a telescoping support tube;
one or more landing sensors;
one or more beacon lights;
one or more solar panels;
a display device; and
an input keypad.

5. The system of claim 1, wherein the node within the smart landing pad communicates with a network controller of the unmanned vehicle to receive authorization for a particular unmanned vehicle to land.

6. The system of claim 1, wherein the node of the smart landing further comprises: a peripheral interface for connecting 3rd party devices for use by the node; and a blockchain processor of providing a blockchain harvesting, mining, logging, ledger and recording for use with other blockchain harvesting, mining, logging, ledgers, and recording, in other nodes within the drone unmanned system service network to provide a secure and redundant record of all deliveries and autonomous drone flights.

7. The system of claim 1, wherein the blockchain processor is accessible by 3rd party nodes.

8. The system of claim 1, wherein the multi-modal unmanned vehicle good delivery system further comprises at least one of the following: an unmanned aircraft system (UAS), an unmanned aircraft vehicle (UAV), a vertical take-off and landing vehicle (VTOL), electric vertical take-off and landing vehicle (EVTOL), a vertical short take-off and landing vehicle (VSTOL), a short take-off and landing vehicles (STOL), an electric take-off and landing vehicle (eSTOL), a conventional take-off and landing vehicle (CTOL), an electric take-off and landing vehicle (eCTOL), an autonomous vehicles (AV), a connected and autonomous vehicles (CAV), a passenger air vehicle (PAV), an electric passenger air vehicles (ePAV) or, a robotic UAV/UAS, autonomous ground transport vehicles or a ground robotic platform.

9. The system of claim 1, wherein the user receives the notification over a user device which includes but not limited to a smart watch, a mobile device, a smart tv, a smart tablet, a laptop etc.

10. The system of claim 1, wherein the user device further comprises:
a. a display, wherein the display displays the application;
b. a touch screen attached to the display for accepting inputs from the user through a user interface; and
c. one or more electronic components for processing the authentication.

11. The system of claim 1, wherein the vehicle flight planner is operable to continuously determine the optimal route during travel to the destination location.

12. A smart AI/ML vertiport system for unmanned vehicle management, comprising:
a. a plurality of unmanned vehicles for delivering a good from a source location to a destination location,
wherein a unmanned vehicle flight planner is configured to select one of the plurality of unmanned vehicles and send a flight itinerary to deliver a good from the source location to the destination location;
b. a charging station for charging the unmanned vehicle based on the determination of the depletion of charge level of the unmanned vehicle;
c. a good delivery system for receiving an order from a user through a user device and initiate the selected unmanned vehicle for transporting a good from the source location to the destination location and
d. a vertiport-in-a-box at the destination location for receiving the good of a user from the unmanned vehicle on to a smart landing pad within the vertiport-in-a-box, wherein the smart landing pad determines a frequency of the smart doorbell and connects to the smart doorbell for generating a delivery notification to the user by ringing the smart doorbell.

13. The method of claim 12, wherein the plurality of unmanned vehicles are fully autonomous, un-crewed, semi-autonomous, or partially controlled by a user.

14. The method of claim 12, further comprising a GPS system configured to guide the plurality of unmanned vehicles to the destination location by the unmanned vehicle flight planner.

15. The method of claim 12, wherein the smart landing further comprises a battery for use when solar panels and or inductive charging pads are not sufficient to support a node of the smart landing pad.

16. The method of claim 12, wherein the smart landing pad further comprises a remote control device to operate the nodes of the smart drone mailbox landing pad and charging station.

17. The method of claim 12, wherein the unmanned vehicle can be but not limited to a drone, an un-crewed vehicle, an autonomous vehicle, an autonomous robotic device etc.

18. The method of claim 12, wherein the user needs to authenticate for identity verification in order to receive the delivered good, wherein the authentication is performed using a user device.

19. The method of claim 12, the vehicle flight planner determines an optimal route based on weather condition information.

20. The method of claim 12, the unmanned vehicle can charge at a nearby charging station within the route determined by the flight planner.
